(19) United States
(12) Patent Application Publication
(10) Pub. No.: US 2017/0208825 A1
(43) Pub. Date: Jul. 27, 2017

(54) GASEOUS TRANSFER DEVICE

(71) Applicant: Alan Backus, Los Angeles, CA (US)

(72) Inventor: Alan Backus, Los Angeles, CA (US)

(21) Appl. No.: 15/003,178

(22) Filed: Jan. 21, 2016

(51) Int. Cl. A23B 4/052; A47J 37/07; A23L 5/10

(52) U.S. Cl. CPC A23B 4/0523; A23L 5/17; A47J 37/0786; A23V 2002/00

(57) ABSTRACT

Devices herein are directed to gaseous medium generation and its transfer. This includes transfer, as a non-limiting and non-exhaustive example, of wood smoke to foods.

Devices are also shown which use, steady and/or varying pressure and/or vacuum, optionally in combination with gaseous transfer devices, to prepare foods.

A device shown which uses strong sound waves in the preparation of foods.

### TECHNICAL FIELD

The present application is directed toward gaseous transference devices, and more particularly to such devices which use gaseous transfer to convey: taste, texture, medicinal properties, appearance, and other characteristics; to various items, including, but not limited to, foods.

### BACKGROUND

Gaseous transference is the process by which an article's fragrance, and/or flavor, and/or appearance, and/or texture, and/or other characteristics are altered by exposing the article to a gaseous agent, as opposed to a solid, or semi-liquid, or liquid agent.

As an example, basting a turkey with sauce which contains sugar, may help the turkey turn brown and sweeten both its taste and smell during the cooking process. But this process uses a solid, liquid, and/or semi liquid transfer agent to accomplish this (namely the sugar sauce), and therefore does not use gaseous transference.

But contrast this to smoking the same turkey. The smoking process, like the sugar process, will affect the appearance, fragrance, texture and/or the taste of the turkey. However, this process, smoking, is done entirely by exposing the turkey only to a gaseous agent, namely the smoke. No solid, liquid, or semi liquid is involved.

This is gaseous transference.

Many cultures have used food smoking to enhance food preservation and add flavor and fragrance. Typically, items, such as foods, are surrounded by gaseous material, including but not limited to, smoke, during hot, cold, or room temperature conditions.

In general, the devices used have been large, messy, and unsuitable for convenient indoor household use.

Recently, however, several new devices have entered the US market which use modified pressure cookers, that have wood charring means within their food containment vessels, to combine smoke with foods.

Because these devices use pressure steaming as their primary way of preparing food, results may be limited and/or unsatisfactory to some people, especially for certain specific foods.

Also, getting these devices entails users buying a large new expensive kitchen appliance, which may be redundant in most regards, to pressure cookers they may already own.

Although this may be acceptable to some, it may be totally unacceptable to others.

Such new specialized devices also must compete with other kitchen appliances for valuable kitchen countertop and storage space.

### SUMMARY

Several devices are shown which generate and convey various gaseous materials.

Also, several devices are shown which improve on current pressure cooker hardware, whether or not the hardware possesses a smoking function.

Devices are also shown which use oscillating gaseous pressure in their cooking processes.

### BRIEF DESCRIPTION OF THE DRAWINGS

Various embodiments will become better understood with regard to the following description, appended claims and accompanying drawings wherein:

FIG. 1 is a perspective of an example embodiment of gaseous transference embodiment 100.

FIG. 2 is a side view of an example embodiment of a gaseous transference embodiment 100.

FIG. 3 is an exploded perspective view of an example embodiment of a gaseous transference embodiment 100.

FIG. 4 is an exploded perspective view of g an example embodiment of a gaseous transference embodiment 142.

FIG. 5 is a perspective of an example gaseous transference embodiment 142, with its plunger button 164. In its aft 166 position.

FIG. 6 is a perspective of an example gaseous transference embodiment 142, with its plunger button 164. In its forward 162 position.

FIG. 7 is a perspective of an example gaseous transference embodiment 174.

FIG. 8 is a perspective of an example gaseous transference embodiment 196.

FIGS. 9, 10, 11, 12, 13, 14, 14a, and 14b are perspectives, illustrating example embodiments of various uses for gaseous transference devices.

FIG. 15 is a perspective of example embodiment 210.

FIG. 16 is a detail of FIG. 15, as indicated in FIG. 15.

FIG. 17 is a perspective of gaseous transference example embodiment 230.

FIG. 18 is an exploded perspective of gaseous transference example embodiment 230.

FIG. 19 is a partially exploded perspective gaseous transference example embodiment 250.

FIG. 20 is a perspective of gaseous transference example embodiment 250.

FIG. 21 is an exploded perspective of gaseous transference example embodiment 250.

FIG. 22 is a perspective of gaseous transference example embodiment 264.

FIG. 23 is a side view of gaseous transference example embodiment 264.

FIG. 24 is a perspective of gaseous transference example embodiment 280.

FIG. 25 is a section through FIG. 24, as indicated in FIG. 24.

FIG. 26 is a perspective of article 290 resting on wrapping sheet 292.

FIG. 27 is a perspective of article 290 wrapped in wrapping sheet 292, being injected with gaseous transference medium.

FIG. 28 is a perspective of article 298 resting in open topped, rectangular pan 302.

FIG. 29 is a perspective of open topped pan 302, covered with pliable sheet 300, being injected with gaseous transference medium.

FIG. 30 is a perspective of article 304 resting on plate 306 with pliable sheet 308 above article 304.

FIG. 31 is a perspective of article 304 resting beneath pliable sheet 308, being injected with gaseous transference medium.

FIG. 32 is a perspective of sealed cartridge 312.

FIG. 33 is an exploded perspective of containment tube 314 and cartridge element 316.

FIG. 34 is a perspective of gaseous transference example embodiment 310.

FIG. 35 is a perspective of gaseous transference example embodiment 332.

FIG. 36 is an exploded perspective of gaseous transference example embodiment 332.

FIG. 37 is a perspective of gaseous transference example embodiment 352.

FIG. 38 is an exploded perspective of gaseous transference example embodiment 352.

FIG. 39, is a perspective of a one-way valve exterior.

FIG. 40 is an exploded perspective of one-way valve example embodiment 368.

FIG. 41 is an exploded perspective of one-way valve example embodiment 374.

FIG. 42 is an exploded perspective of one-way valve example embodiment 388.

FIG. 43 is a perspective of gaseous transference example embodiment 400.

FIG. 44 is a perspective detail showing hand compressed bellows 414 and sub components attached thereto.

FIG. 45 is an exploded perspective of gaseous transference example embodiment 400.

FIG. 46 is a perspective of gaseous transference example embodiment 434.

FIG. 47 is a perspective of an example embodiment of a pressure cooking device being injected with gaseous transference medium.

FIG. 48 is a perspective of example embodiment 450.

FIG. 49 is a perspective of example embodiment 450, taken from the same viewpoint as FIG. 48 with outer cover 471 removed.

FIG. 50 shows for sectional views, as indicated in FIG. 49, of example embodiment 450 in operation.

FIG. 51 is a perspective of example embodiment 480.

FIGS. 52 and 53 are perspective sectional views, as indicated in FIG. 51, of example embodiment 480 in operation.

FIG. 54 is an exploded perspective view of example embodiment 480.

FIG. 55 is a perspective of example embodiment 468.

FIG. 56 is an overhead detail of example embodiment 498.

FIG. 57 is a perspective of example embodiment 498.

FIG. 58 is a detail of FIG. 57, as indicated in FIG. 57.

FIG. 59 is a perspective of example embodiment 510.

FIG. 60 is a perspective of example embodiment 510, with cover 512 removed, taken from the same viewpoint as FIG. 59

FIGS. 61, 62, 63, 64, and 65, are graphs indicating pressure changes within a sealed cooking vessel.

FIG. 66 is a perspective of example embodiment 516.

FIG. 66a is a detail of FIG. 66, as indicated in FIG. 66.

FIG. 66b is a detail of FIG. 66, as indicated in FIG. 66.

FIG. 67 is a perspective of example embodiment 516.

FIG. 67a is a detail of FIG. 67, as indicated in FIG. 67.

FIG. 67b is a detail of FIG. 67, as indicated in FIG. 67.

FIG. 68 is a perspective of example embodiment 544.

FIG. 68a is a detail of FIG. 68, as indicated in FIG. 68.

FIG. 68b is a section taken through FIG. 68a, as indicated in FIG. 68a.

FIG. 69 is a perspective of example embodiment 552.

FIG. 69a is a detail of FIG. 69, as indicated in FIG. 69.

FIG. 70 is a perspective of example embodiment 552.

FIG. 70a is a detail of FIG. 70, as indicated in FIG. 70.

FIG. 71 is a partially exploded perspective of example embodiment 552.

FIG. 72 is a graph indicating pressure changes occurring within the cooking vessel of embodiment 552.

FIG. 73 is a perspective of example embodiment 568.

FIG. 74 is a an exploded perspective of example embodiment 568.

FIG. 75 is a section through FIG. 73, as indicated in FIG. 73.

FIG. 76 is a section through FIG. 73, as indicated in FIG. 73.

FIG. 77 is a perspective of gaseous transference example embodiment 580.

FIG. 78 is a perspective of gaseous transference example embodiment 580.

FIG. 79 is an exploded perspective of gaseous transference example embodiment 580.

FIG. 80 is a perspective of gaseous transference example embodiment 596.

FIG. 81 is a perspective of gaseous transference example embodiment 612.

FIG. 82 is a perspective of gaseous transference example embodiment 616.

### DETAILED DESCRIPTION

Gaseous Transference Embodiment 100:

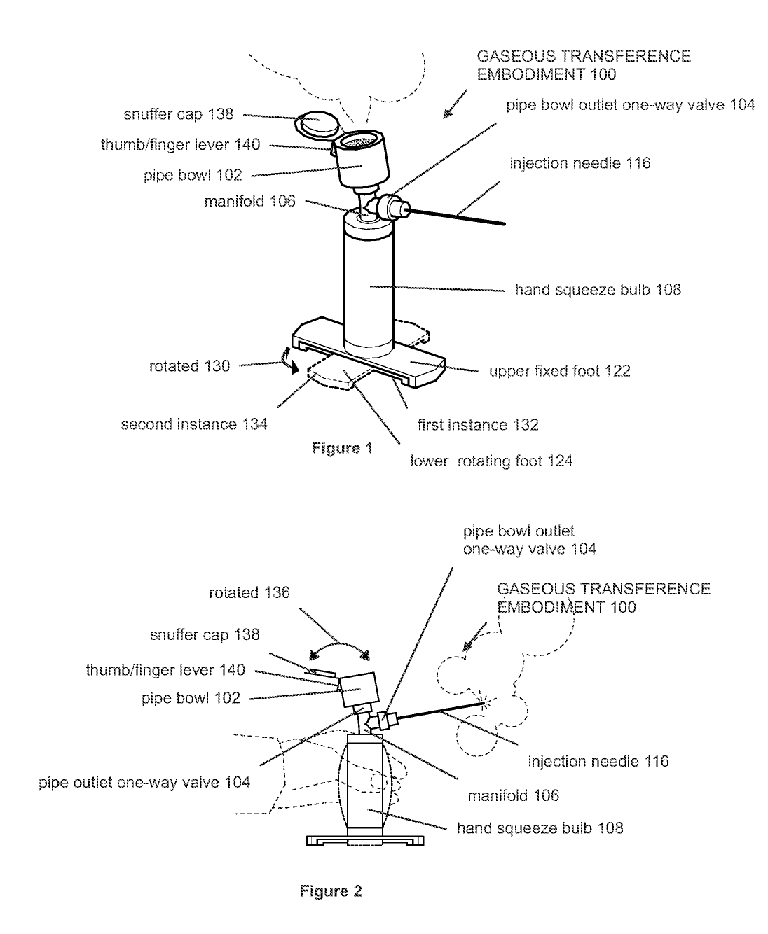

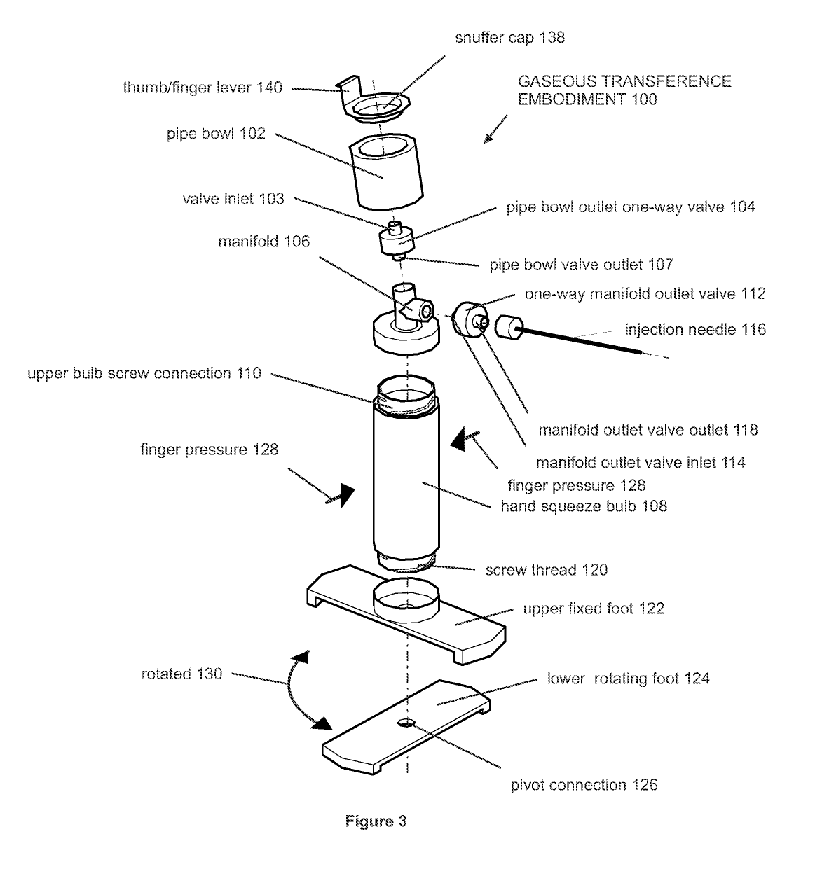

FIGS. 1 through 3, show gaseous transference embodiment 100, including: (referring in particular to FIG. 3) pipe bowl 102, which is connected to valve inlet 103 of pipe bowl outlet one-way valve 104, which in turn is connected to manifold 106 through pipe bowl valve outlet 107, and which in turn is connected to hand squeeze bulb 108, through upper bulb screw connection 110.

Pipe bowl outlet one-way valve 104, allows gases to pass from pipe bowl 102 into manifold 106, but prevents gases passing back from manifold 106 to pipe bowl 102.

Manifold 106 is also connected to one-way manifold outlet valve 112 through manifold outlet valve inlet 114. On the other side of one-way manifold outlet valve 112 from manifold outlet valve inlet 114, is manifold outlet valve outlet 118, which connects to the back end of injection needle 116.

One-way manifold outlet valve 112 allows gases to pass from manifold 106 into injection needle 116, but prevents gases from passing from injection needle 116 back into manifold 106.

Screw thread 120, located at the base of hand squeeze bulb 108, screw attaches to upper fixed foot 122.

Lower rotating foot 124, connects to upper fixed foot 122 through pivot connection 126.

Hand squeeze bulb 108 is both pliable and tubular, having an open top and an open bottom. Unscrewing manifold 106 from upper bulb screw connection 110, and simultaneously unscrewing upper foot 122 from screw thread 120, allows for easy cleaning of the interior of hand squeeze bulb 108. Such a screw connection is similar to that used on plastic ketchup containers found in many restaurants.

In example gaseous transfer embodiments herein shown herein which use one-way valves, both pipe bowl outlet one-way valve 104, and one-way manifold outlet valve 112, are configured to be disassembled by hand, to permit thorough cleaning of their interiors.

In operation, pipe bowl 102 is filled with combustible material, such as, for a non-limiting and non-exhaustive example, woodchips.

This material is then lit using, again as a non-limiting, and non-exhaustive example, a match or a common cigarette butane lighter or the like. During this process of lighting the combustible material, hand squeeze bulb 108 is repeatedly finger pressure 128 compressed and alternately released.

Each time finger pressure 128 is applied, it distorts and thus reduces the internal volume of pliable hand squeeze bulb 108 and forces gases out of it. Pipe bowl outlet one-way valve 104 prevents escape of these gases into pipe bowl 102. One-way manifold outlet valve 112, unidirectionally directs these gases out through injection needle 116.

Each time finger pressure 128 is released from hand squeeze bulb 108, the internal volume of hand squeeze bulb 108 increases, causing gases to be sucked from and through the contents of pipe bowl 102, and out through pipe bowl outlet one-way valve 104. One-way manifold outlet valve 112 prevents gases from entering into squeeze bulb 108 through injection needle 116, during this squeeze bulb 108 release process.

Thus repetitious squeezing and releasing of hand squeeze bulb 108, has the same effect of sucking repeatedly on a smoking pipe, in order to help light it. Once the material inside of pipe bowl 102 is ignited, the smoke produced can be pumped out injection needle 116 simply, again, by repetitiously squeezing 128 and releasing hand squeeze bulb 108.

As both non-exhaustive and non-limiting examples, after pipe bowl 102 content ignition, injection needle 116 may be inserted directly into foods and/or other articles, and/or into spaces, including, but not limited to enclosed spaces, surrounding foods or other articles, and gaseous smoke directly injected to impart: flavor, fragrance, preservative, appearance, texture and/or other characteristics to foods and other articles.

Materials having nonstick characteristics, such as by way of non-limiting and non-exhaustive examples, polypropylene, polyethylene, acetyl, silicon rubber, Teflon, and nylon, may be advantageously used to aid in cleaning.

Some kinds of smoke and other gaseous materials, are very difficult to remove, so nonstick characteristics are very advantageous on parts of the device which might have contact with smoke, such as, by way of non-limiting and non-exhaustive examples, the interiors of hand squeeze bulb 108, manifold 106, pipe bowl outlet one-way valve 104, and/or one-way manifold outlet valve 112, as well as other surfaces. This is true for this embodiment device, as well as for most and/or all other gaseous transference devices shown herein.

Lower rotating foot 124, may be rotated 130 to, in a first instance 132 (FIG. 1), provide compactness for storage when it is aligned with upper fixed foot 122; and in a second instance 134, when rotated generally 90° from first instance 132, to provide additional stability when the device is rested on a flat surface.

Snuffer cap 138, may be rotated 136 from a first open position shown in FIGS. 1 and 2, to a second closed position shown in FIG. 3, in order to extinguish ignited materials within pipe bowl 102. This may be helpful to reduce consumption of ignited materials contained within pipe bowl 102 after smoke injection has occurred, as well as to reduce unwanted smoke, and/or other gaseous materials, released into the immediate environment, such as a kitchen or other space.

Thumb/finger lever 140 may make it easier to open and close snuffer cap 138.

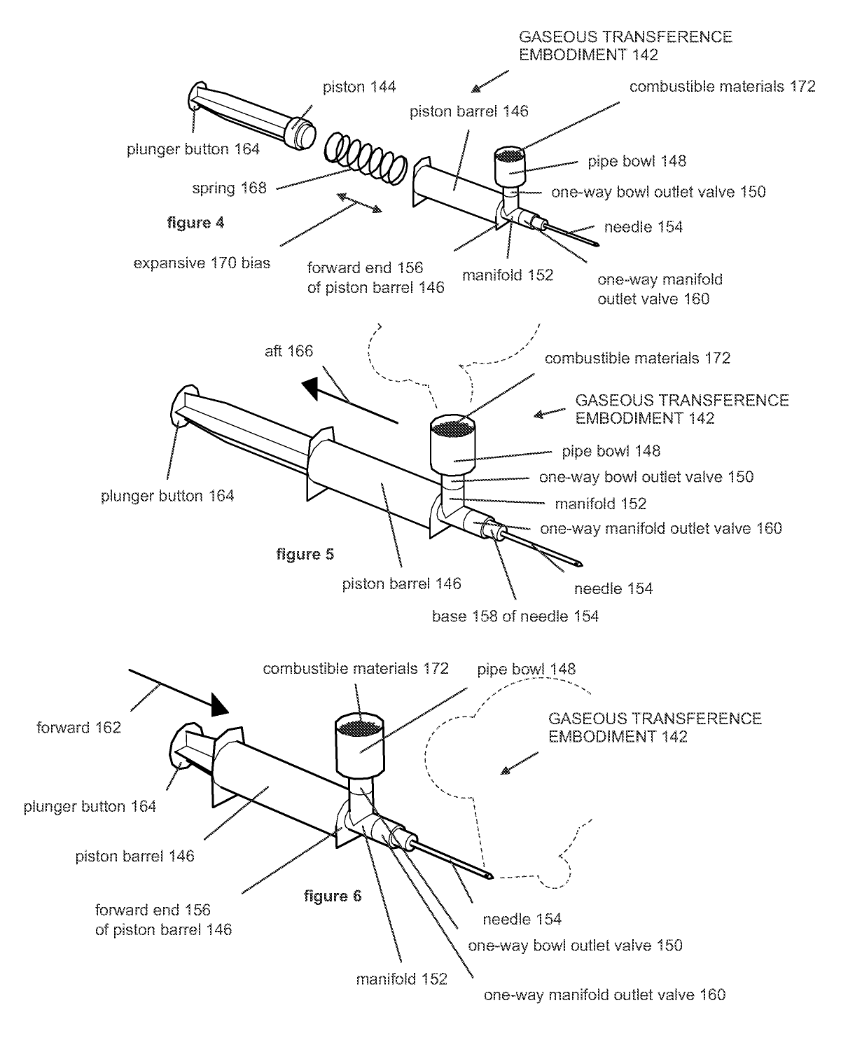

Gaseous Transference Embodiment 142 (FIGS. 4, 5 and 6):

FIGS. 4, 5 and 6 show gaseous transfer embodiment 142, which contrasts to embodiment 100 in that compressive and vacuum forces used to drive smoke and/or other gaseous materials through the device, are not generated by squeezing and releasing a pliable bulb, as was the case with gaseous transference embodiment 100, but rather are generated by oscillating hand driven linear movement of piston 144 within piston barrel 146, similar to the way a medical syringe operates.

Embodiment 142 comprises: pipe bowl 148, which is connected to the inlet end of one-way bowl outlet valve 150, which at its outlet end is connected to manifold 152, which in turn connects to both forward end 156 of piston barrel 146, and, by way of one-way manifold outlet valve 160, to base 158 of needle 154.

In operation, as a non-limiting and non-exhaustive example, combustible materials, such as woodchips, are placed within pipe bowl 148.

These combustible materials 172 are then lit, and forward 162 hand pressure is applied to plunger button 164, causing piston 144 to move forward 162 within piston barrel 146. This action forces gases within piston barrel 146, to exit through one-way manifold outlet valve 160, and subsequently through needle 154.

One-way bowl outlet valve 150, prevents gas being expelled from piston barrel 146, from exiting through pipe bowl 148.

Hand pressure on plunger button 164 is then released, causing aft 166 movement of piston 144 within piston barrel 146, due to expansive 170 bias pressure, created by compression spring 168.

This aft 166 movement, expands the volume within piston barrel 146 created by piston 144 disposition. This results in air being pulled through combustible materials 172, which helps further to ignite them, and also transports smoke created by the combustible materials, into and through one-way bowl outlet valve 150, and into piston barrel 146.

This oscillating forward 162 and aft 166 movement of piston 144 is then repeated multiple times. Each oscillation results in gases being pulled through ignited combustible material 172 contained within pipe bowl 148, and smoke generated by the ignited combustible material 172, being pulled through one-way bowl outlet valve 150, and being subsequently expelled through one-way manifold outlet valve 160, and needle 154.

Gaseous transference embodiment 142 shares many nonstick and other cleaning needs, with gaseous transference device 100. In addition, piston barrel 146 and piston 144, due to their relative lateral movement, are prone to sticking. Materials chosen for these components must take account of this tendency for mechanical jamming.

As a non-limiting and non-exhaustive example, hard (low pliability), nonstick materials, are suitably be used for both components; such as using: nylon, acetyl, Teflon™ and/or polypropylene, to fabricate one or both components. This contrasts with medical syringes, which commonly use a highly pliable elastomer in the construction of their pistons.

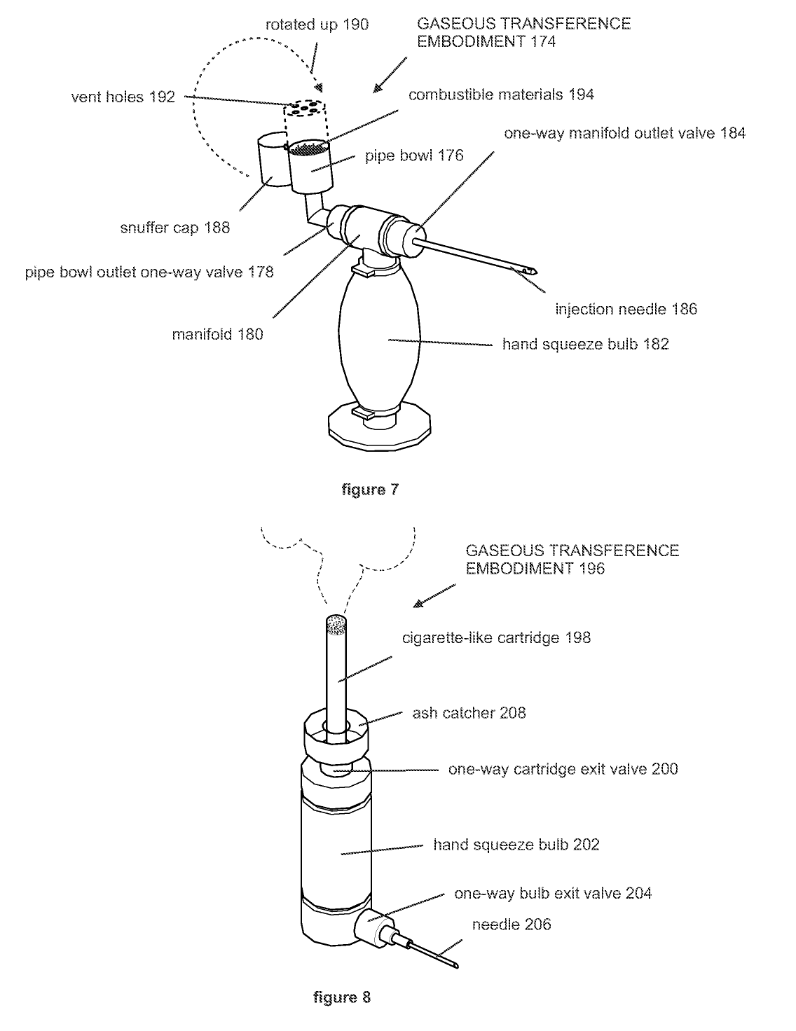

Gaseous Transference Embodiment 174 (FIG. 7):

FIG. 7 shows gaseous transference embodiment 174, which shares much in common with gaseous transfer embodiment 100. Gaseous transference embodiment 174 has: pipe bowl 176, pipe bowl outlet one-way valve 178, manifold 180, hand squeeze bulb 182, one-way manifold outlet valve 184, and injection needle 186, all of which suitably share similarities with their commonly named gaseous transference device 100 components. However there are variations in the configuration of the gaseous transference embodiment 174 components, relative to those of embodiment 100.

Also, when snuffer cap 188 is rotated up 190, vent holes 192 in stuffer cap's 188 roof, allow for slow combustion of combustible materials 194, to help conserve them, while still allowing continuous combustion, without the need for re-ignition.

Gaseous Transference Embodiment 196 (FIG. 8):

FIG. 8 shows gaseous transference embodiment 196, which uses cigarette-like cartridge 198, which, as a non-limiting and non-exhaustive example, may use an outer wrap of low odor cigarette paper, or other low odor material, and be filled, with a combustible material, such as woodchips for food smoking.

Alternatively, an outer wrap with a desirable burning smell may be used.

Cartridge 198 can be made at any scale.

As non-limiting and non-exhaustive examples, it is suitably made to the dimension of small or slim cigarettes. Alternatively, its size might mimic a very large cigar. All sizes intermediate of or exceeding these examples, might also be reviewed for their usefulness under specific circumstances.

Also, it's easy to fabricate an adapter to attach the upper portions of embodiment 196, including ash catcher 208 and cigarette-like cartridge 198, to the pipe bowls on embodiments taught herein which utilize pipe bowls, such as those shown in FIGS. 1, 2, 3, 4, 5, 6, and 7 as well as other pipe bowls.

Gaseous transference embodiment 196 includes one-way cartridge exit valve 200, which receives gaseous input from cigarette-like cartridge 198, and unidirectionally transmits gaseous output into hand squeeze bulb 202.

Gases escaping from hand squeeze bulb 202, are forced to exit through one-way bulb exit valve 204, and subsequently through needle 206.

By using a cigarette-like cartridge versus a pipe bowl, it may be easier, and be more reliable, to burn combustible material.

It also may be easier to light combustible material in cartridge 198, due to its cigarette-like construction, when compared to ignited materials in a pipe bowl.

It also may more completely burn the combustible material it contains, when compared to a pipe bowl.

Ash catcher 208 acts as an ashtray to collect burned materials.

Operation is similar to earlier embodiments, involving oscillate squeezing of hand squeeze bulb 202, while cigarette-like cartridge 198 is lit.

Materials and cleaning requirements are also similar to these earlier embodiments.

The placement of needle 206 low on the front face of hand squeeze bulb 202, permits, in many cases, easier insertion of needle 206 into foods and other objects.

The high placement of cigarette-like cartridge 198 helps keep it out of the way of the embodiment operator during use.

Embodiment Uses:

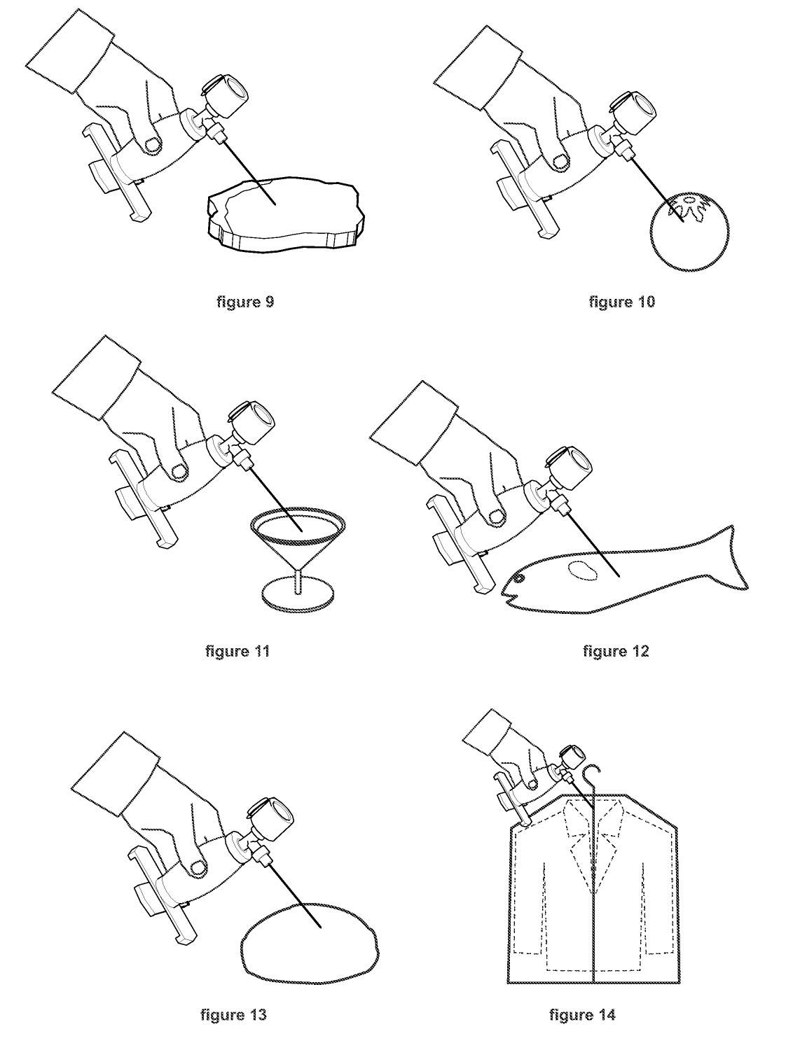

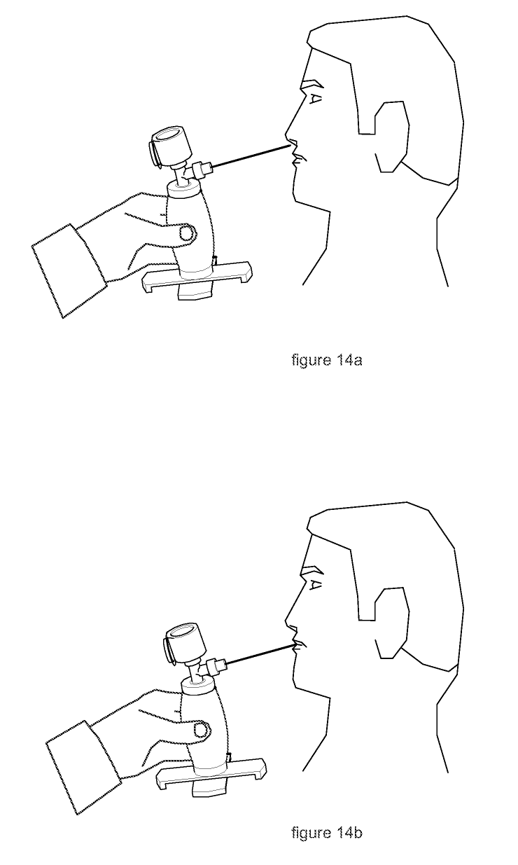

FIGS. 9 through 14, as both non-limiting and non-exhaustive examples, show several potential uses for virtually all embodiments taught herein, including injecting and/or distributing smoke, and/or fragrances, and/or flavors, and/or medicines (such as caffeine, herbal medicines and others) directly into, and/or directly into the surroundings and/or environs of: meats (FIG. 9), fruits and other foods (FIG. 10), mixed drinks (FIG. 11), fish and fowl (FIG. 12), vegetables (FIG. 13), and/or clothing containing garment bags (FIG. 14), and/or human noses (FIG. 14a, and/or human mouths (FIG. 14b), and/or other human anatomy, and/or other locations and/or items.

Specialized tips, such as, by way of just one non-limiting, and non-exhaustive example, a mouthpiece, may be used to facilitate such uses, either attached to the end of the injection needle, or as a replacement for injection needle, or in combination with being attached to the end of a flexible tube, and/or using some other coupling means.

Many, many other uses are also available.

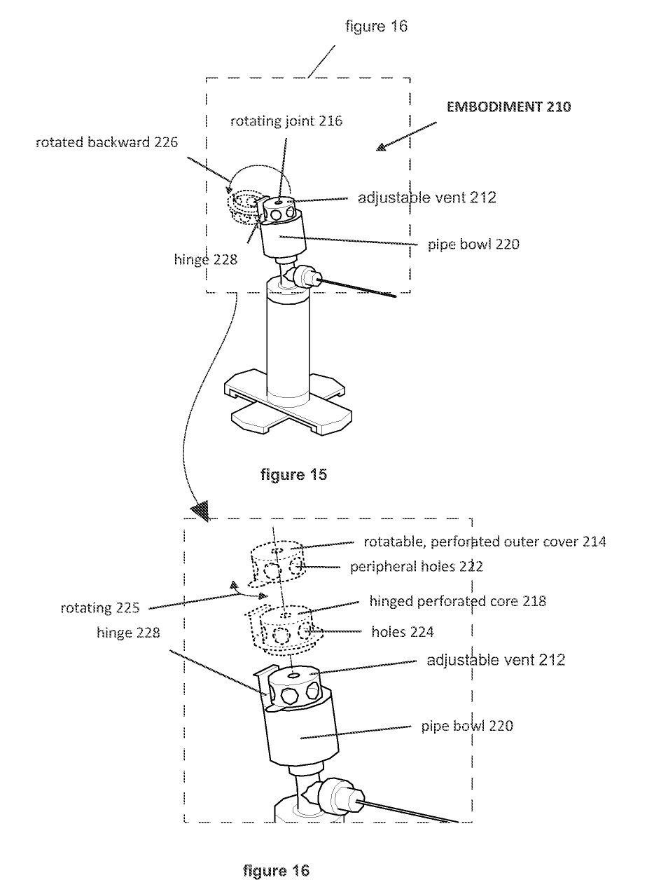

Gaseous Transference Embodiment 210 (FIGS. 15 and 16):

FIGS. 15 and 16, show gaseous transference embodiment 210 which shares much in common with gaseous transfer embodiment 100. However, gaseous transference embodiment 210 includes adjustable vent 212, which is comprised of rotatable, perforated outer cover 214, which surrounds and is connected, through rotating joint 216, to hinged perforated core 218.

Adjustable vent 212 allows control of the speed of the burning process of combustible materials contained within pipe bowl 220. It does this by rotating 225 perforated outer cover 214, relative to perforated core 218. This places peripheral holes 222 in perforated core 218, into and out of alignment with holes 224 in hinged peripheral core 218, thus constricting, to various degrees, gaseous ingress and egress, into and from, pipe bowl 220.

Adjustable vent 212, is hinged to pipe bowl 220 through hinge 228, and adjustable vent 212 may be rotated backward 226 when not in use (FIG. 15).

Hinge 228 is configured to also allow user discretionary complete detachment of adjustable vent 212 from pipe bowl 220, for cleaning or other purposes.

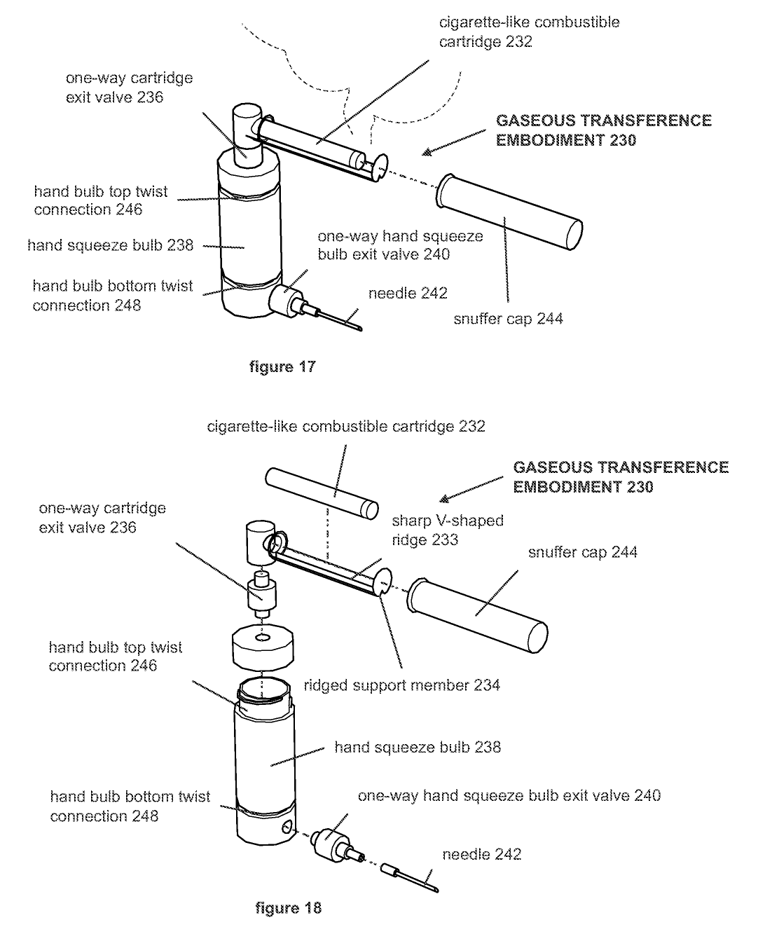

Gaseous Transference Embodiment 230 (FIGS. 17 and 18):

FIGS. 17 and 18 show gaseous transference embodiment 230.

Gaseous transference embodiment 230 places cigarette-like combustible cartridge 232 in a horizontal disposition, supported by ridged support member 234.

An adapter could be used, similar to the adapter which was described earlier for embodiment 196, except this adapter adapts the upper portions of embodiment 230 including: ridged support member 234, cigarette-like combustible cartridge 232 and snuffer cap 244; to fit into and function in pipe bowls, on embodiments taught herein having pipe bowls such as those shown in FIGS. 1, 2, 3, 4, 5, 6, and 7.

Ridged support member 234 has sharp V-shaped ridge 233, disposed along member's 234 length. This provides support to unburned portions of cartridge 232, but allows ash to fall down into the lower portion of ridged support member 234, which then acts as an ashtray.

Ridged support member 234 may be made of screening, or may be solid, or may be perforated, across all or some of its surface. The openness of such surfaces, may facilitate burning, and/or if the perforations occur below the portion of cigarette-like combustible cartridge 232, which needs lighting, may facilitate such lighting by permitting heat to easily pass directly through ridged support member 234 (i.e., simply put a lit match directly below cartridge 232, at the point where ignition is desired).

One-way cartridge exit valve 236 directs gaseous output of cigarette-like combustible cartridge 232 unidirectionally into hand squeeze bulb 238.

One-way hand squeeze bulb exit valve 240, only supports unidirectional gaseous flow out of hand squeeze bulb 238, and prevents gaseous flow back into hand squeeze bulb 238.

As both a non-limiting and non-exhaustive example, repetitious squeezing of hand squeeze bulb 238, similar to earlier embodiments, helps ignition and burning of cigarette-like combustible cartridge 232, and pumps smoke produced by cartridge 232 out through needle 242.

Snuffer cap 244 may, at user discretion, be slipped over cigarette-like combustible cartridge 232 after smoking is complete, or at other times, to extinguish cartridge combustion, and help contain any undesirable odors it might emit after smoking has occurred, or at other times.

Hand bulb top twist connection 246, and hand bulb bottom twist connection 248, may be each opened to facilitate cleaning, or for other purposes.

Operation of gaseous transfer embodiment 230 is similar to that of earlier embodiments with hand squeeze bulbs shown herein.

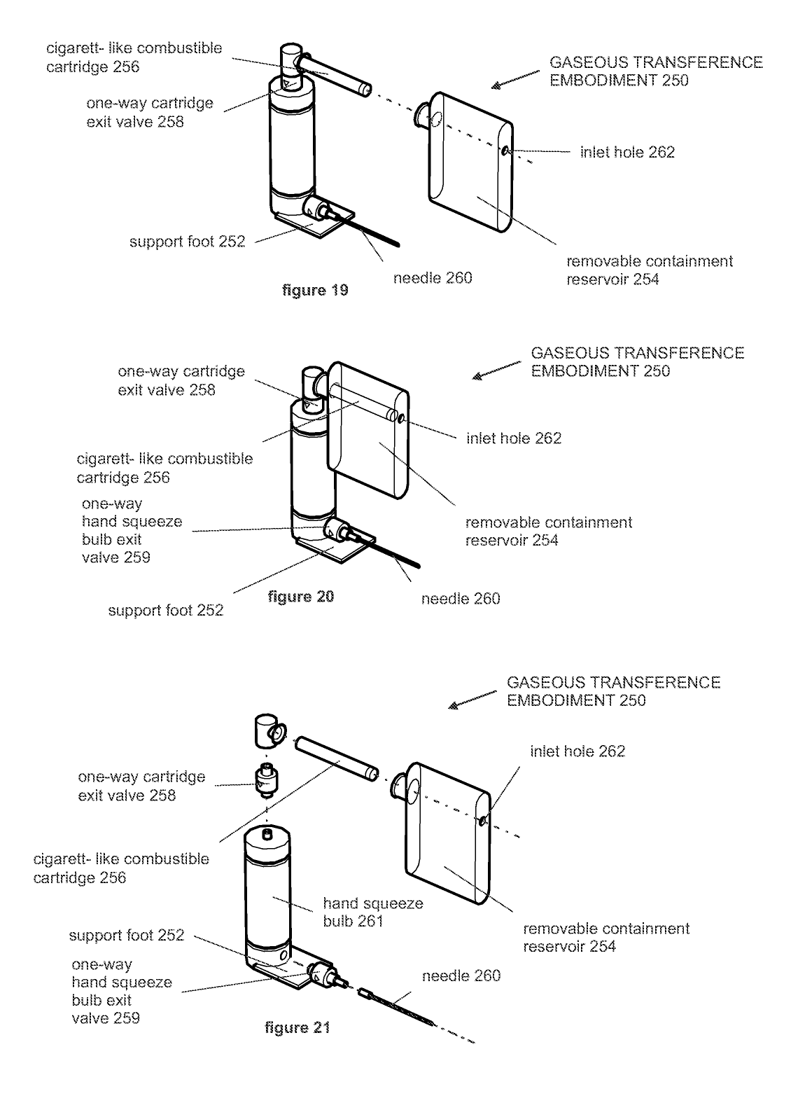

Gaseous Transference Embodiment 250 (FIGS. 19, 20, and 21):

Gaseous transference embodiment 250 is similar in construction to embodiment 230, but includes further: support foot 252, and removable containment reservoir 254.

Support foot 252 helps to stabilize embodiment 250, and allows purchase surfaces to mechanically couple the embodiment to other objects.

Removable containment reservoir 254 may be mounted (as shown in FIG. 20), after cigarette-like combustible cartridge 256 has been lit.

Removable containment reservoir 254 helps block smoke emanating from cigarette-like combustible cartridge 256 from entering directly into surrounding environments, such as kitchens.

Smoke may build up inside removable containment reservoir 254 until the smoke is sucked out, and along the way it is combined with smoke created by the lit cigarette-like combustible cartridge 256, and the whole kit and caboodle is pulled out through one-way cartridge exit valve 258, and eventually exits through one-way hand squeeze bulb exit valve 259 and needle 260 by the repeated pumping of hand squeeze bulb 261.

As gases are pulled out of removable containment reservoir 254, new air is introduced into removable containment reservoir 254, through inlet hole 262. The rate of air introduction through inlet hole 262 controls the combustion rate of cigarette-like combustible cartridge 256.

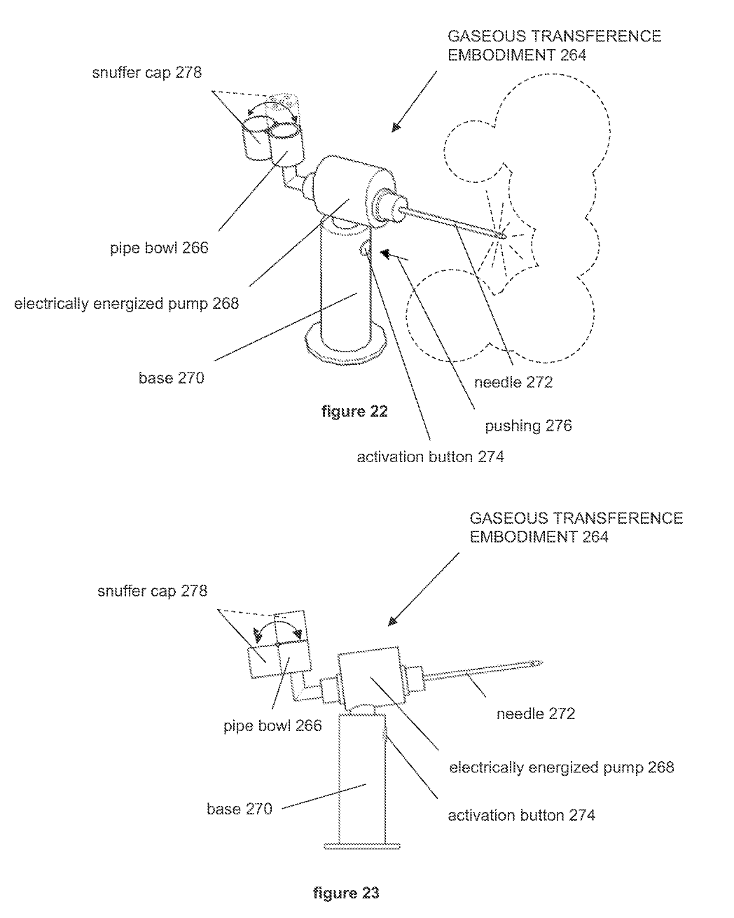

Gaseous Transference Embodiment 264 (FIGS. 22 and 23).

Gaseous transference embodiment 264 comprises pipe bowl 266, which may be adapted to fit cigarette-like combustible cartridges, such as are described herein.

Gaseous transference embodiment 264 also includes electrically energized pump 268, which, as both non-limiting and non-exhaustive examples, may be powered by batteries contained in base 270, or from other electrical sources, including but not limited to wall pack transformers, car batteries, wall power, etc.

Electrically energized pump 268 is designed to unidirectionally move gases from pipe bowl 266 out through needle 272.

Electrically energized pump 268 may be energized by pushing 276 activation button 274, disposed on the forward face of base 270.

Electrically energized pump 268 may be of any one of many different constructions. As non-limiting and non-exhaustive examples, it may utilize: impellers, including but not limited to centrifugal and/or axial impellers; pistons; motor driven moving diaphragms; or other constructions that can move gaseous material.

Snuffer cap 278 functions similarly to snuffer cap 188 shown in FIG. 7 earlier in this specification.

Gaseous transference embodiment 264 features convenience and ease of use associated with an electrically powered device.

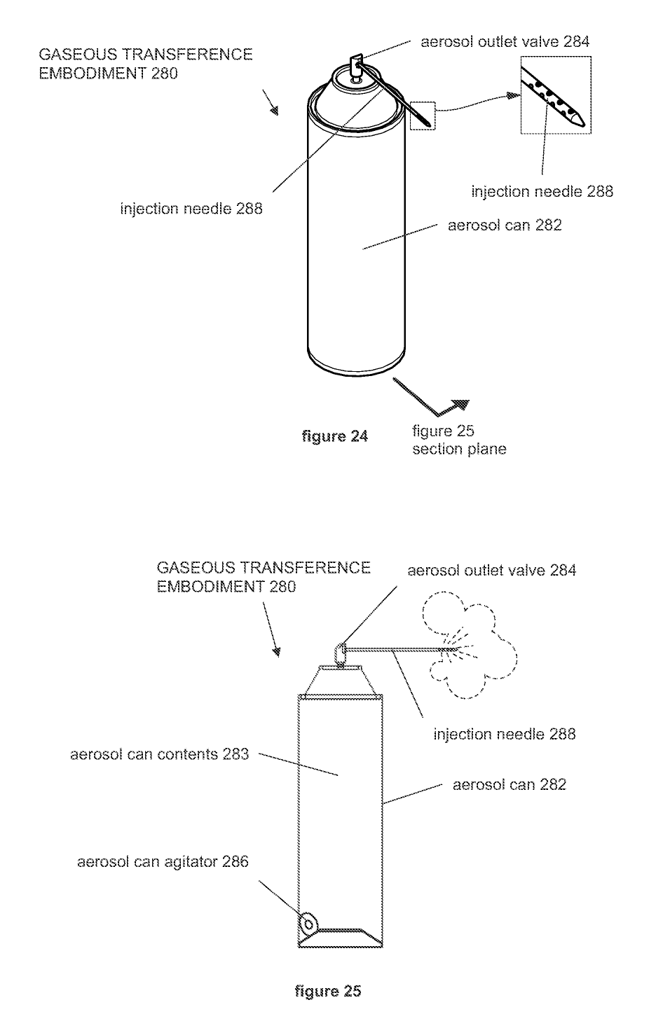

Gaseous Transference Embodiment 280 (FIGS. 24 and 25):

FIGS. 24 and 25 show gaseous transference embodiment 280, which comprises: aerosol can 282, aerosol can contents 283, aerosol outlet valve 284, aerosol can agitator 286, and injection needle 288. Contents of aerosol can 282 are formulated to dispense gaseous materials out of injection needle 288.

Like earlier embodiments shown herein, such gaseous materials are formulated to alter an item's: fragrance, and/or flavor, and/or texture, and/or appearance, and/or other characteristics.

Aerosol can agitator 286, unlike aerosol cans which agitate using ball bearings as agitation elements, as a non-limiting and non-exhaustive example, may use a flat disk-like agitator element, possibly with a hole in its interior, which, due to its shape and larger surface area, may be superior in agitation performance in comparison to a ball bearing agitator, particularly when used with lighter viscosity aerosol fluids.

Injection needle 288 may have a plurality of holes, possibly numbering greater than 4, at its egress end. This may aid in infusing aerosol can contents 283, into foods and other items.

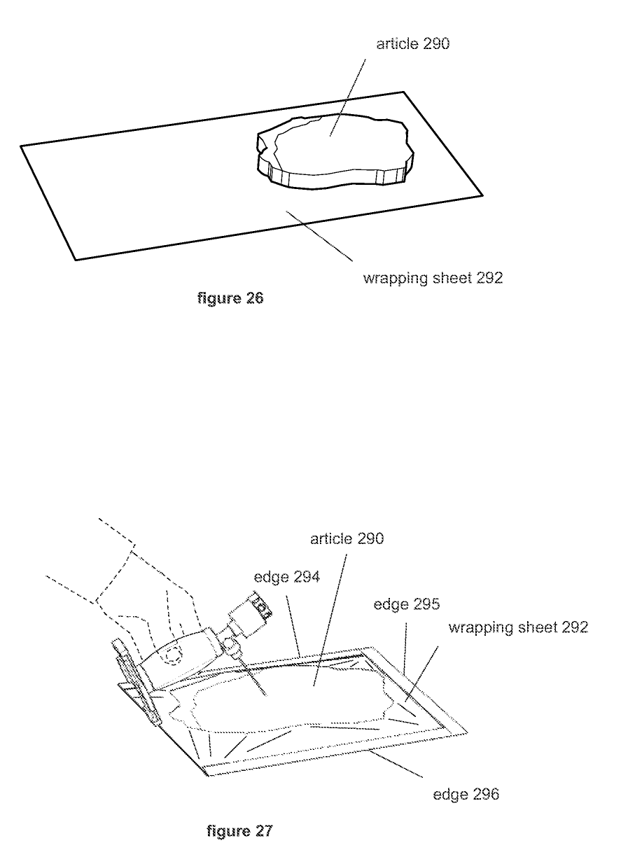

Wrapping Articles—FIGS. 26 and 27:

FIGS. 26 and 27, show article 290, a piece of meat, being contained by wrapping sheet 292. Wrapping sheet 292 may be fabricated from plastic or metal or other pliable sheet, including, but not limited to, plastic home food wrap, and/or aluminum foil.

Wrapping may provide an enclosed space surrounding an article, into which gaseous materials may be introduced.

FIGS. 26 and 27 show wrapping sheet 292 being folded in half over article 290, and then double folded again along edges 294, 295, and 296.

This provides an envelope shaped enclosed space around article 290.

After being injected with gaseous material, these envelope-shaped enclosed spaces along with articles contained within them, may be placed into a variety of environments.

As non-limiting and non-exhaustive examples: articles wrapped in plastic wrapping sheet may be left at ambient temperatures, and/or they may be put into a microwave oven, and/or into a low heat oven, and/or a slow cooker, and/or a sous vide, and/or into a refrigerator or freezer, where smoking or other gaseous transference related processes can occur.

Articles wrapped in aluminum foil might, in addition to the above (except for placement into a microwave oven), be cooked in an oven and/or a pressure cooker.

Using gas transference embodiment 250 (FIGS. 19 through 21) as a non-limiting and non-exhaustive example, after wrapping article 290; gaseous transference from embodiment 250, may occur directly into article 290, and/or into the enclosed environment surrounding article 290. As both a non-limiting and non-exhaustive example, either of these can occur by not fully wrapping one of edges 294, 295, or 296, and inserting needle 260 into any unclosed opening, and then sealing the opening after gaseous injection has occurred.

Either of the above, direct gaseous article injection, or gaseous introduction to the enclosed environment surrounding an article, may also occur by injecting directly through wrapping sheet 292, as shown in FIG. 27, and optionally afterwards, sealing any unwanted holes with a patch or patches.

A variant of this is the use of Ziploc™ type bags, instead of fold wrapping an article in plastic wrapping sheet. Here, an article is placed into a Ziploc™ type bag, and the bag mostly the zip sealed, but still leaving an opening large enough for direct article injection, or for gaseous introduction into the sealed article environment. In either case, after injection, the embodiment needle is removed and the zip seal is fully zip closed.

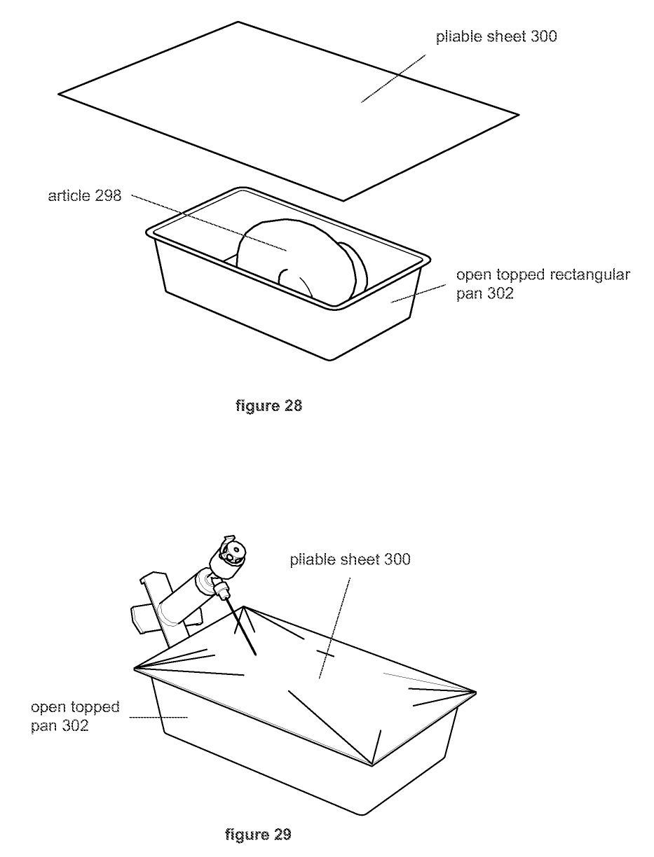

Containing Articles—FIGS. 28 and 29:

FIGS. 28 and 29 show an alternative to FIGS. 26 and 27 for wrapping articles into a sealed environment. Specifically they show article 298, a foul, being contained in an open topped pan 302, using pliable sheet 300, by wrapping pliable sheet 300 over the top edges of open topped pan 302.

Similar to the methods describe for FIGS. 26 and 27, FIGS. 28 and 29 show a non-limiting and non-exhaustive example of creating an enclosed space around article 298.

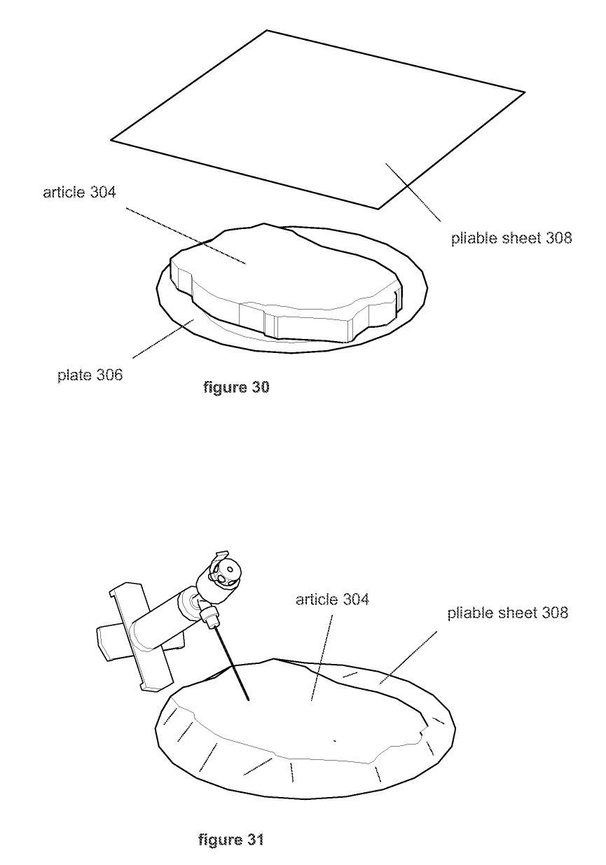

Containing Articles—FIGS. 30 and 31:

FIGS. 30 and 31, show yet another alternative for wrapping articles into a sealed environment. FIGS. 30 and 31 show article 304, a piece of meat, disposed in a sealed environment constructed from plate 306 joining with pliable sheet 308, which is wrapped over the outer perimeter edge of plate 306.

Similar to the methods describe for FIGS. 26 and 27, FIGS. 30 and 31 show a non-limiting and non-exhaustive example of creating an enclosed space around article 304.

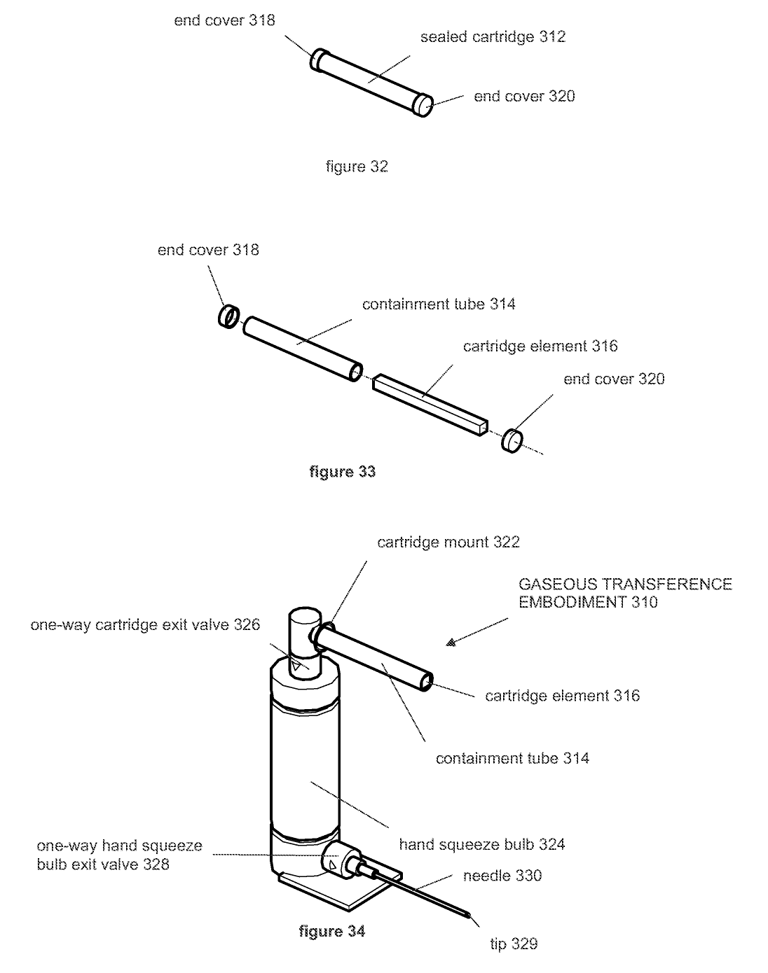

Gaseous Transference Embodiment 310—FIGS. 32, 33, and 34:

FIG. 32 shows sealed cartridge 312 for delivering gaseous materials to gaseous transference embodiment 310.

As shown in FIG. 33, sealed cartridge 312 is comprised of: containment tube 314, which surrounds cartridge element 316, and is capped at either end, by end covers 318 and 320.

Cartridge element 316, when air passes over it, emits gaseous materials, which as non-limiting and non-exhaustive examples, might alter an article's fragrance, and/or flavor, and/or appearance, and/or other characteristics.

Cartridge element 316 might also admit gaseous elements which possess medicinal benefits, including elements derived from herbs and other materials.

Functionally, end covers 318 and 320 are operable to isolate cartridge element 316 during shipping and storage, or at other times.

Before use, covers 318 and 320 are removed and one end of containment tube 314 with cartridge element 316 inside of it, is inserted into cartridge mount 322.

Hand squeeze bulb 324 is then repeatedly compressed and released, causing with each release, a flow of air into containment tube 314 and past its contained cartridge element 316, then passing through one-way cartridge exit valve 326, and ultimately into the interior of hand squeeze bulb 324.

Each compression of hand squeeze bulb 324, results in gaseous outflow from the interior of hand squeeze bulb 324, through one-way hand squeeze bulb exit valve 328, and ultimately out through tip 329 of needle 330. These emitted gaseous materials include mixed gaseous components derived from cartridge element 316.

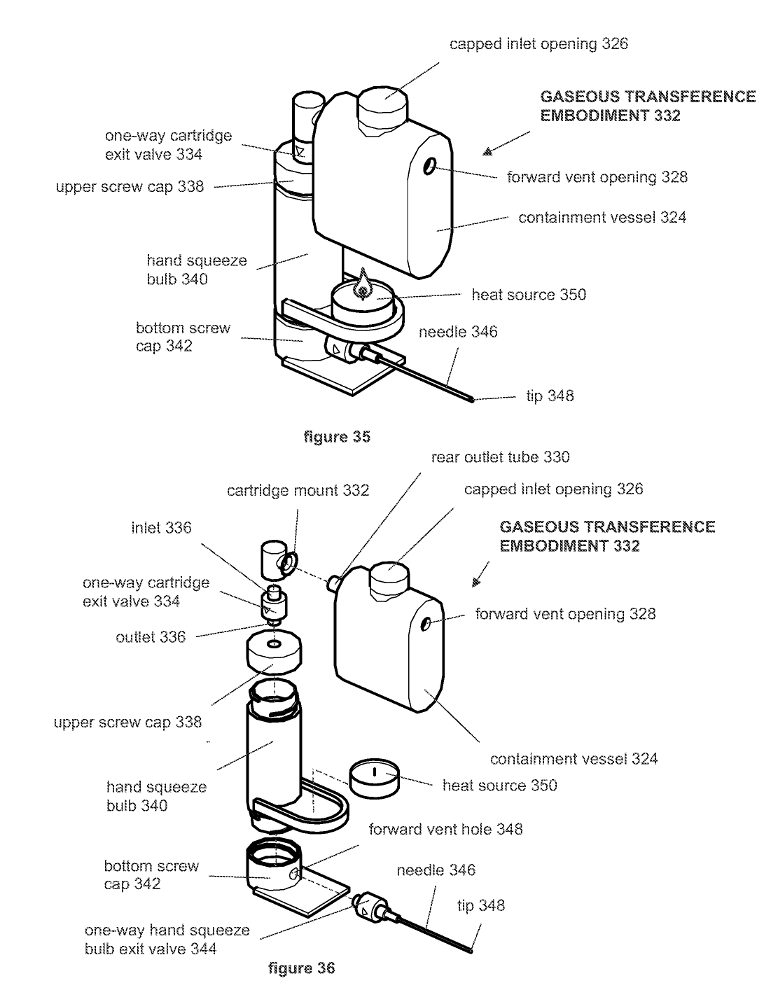

Gaseous Transference Embodiment 332—FIGS. 35 and 36:

FIGS. 35 and 36 show gaseous transference embodiment 322, which is functional to take oils and other liquids, as well as powder and solid substances and heat them to produce gaseous elements which might alter an article's fragrance, and/or flavor, and/or appearance, and/or other characteristics. Likewise, these gaseous elements might possess medicinal benefits.

Gaseous transference embodiment 332 is comprised of: containment vessel 324, which has tank 325, with capped inlet opening 326, forward vent opening 328, and rear outlet tube 330.

Rear outlet tube 330 is configured to mount into cartridge mount 332, which is connected to inlet 336 of one-way cartridge exit valve 334, which then is connected through one-way cartridge exit valve 334 to outlet 336 of one-way cartridge exit valve 334, which in turn is connected to the interior of hand squeeze bulb 345 by passing through upper screw cap 338, which covers the upper end of hand squeeze bulb 340.

Bottom screw cap 342 encloses the bottom end of hand squeeze bulb 340, and has forward vent hole 348, which mounts one-way hand squeeze bulb exit valve 344, which in turn directs one-way flow of gaseous materials into needle 346, which then results in these gaseous materials exiting through tip 348 of needle 346.

Heat source 350, shown as a non-limiting and non-exhaustive example as a candle, warms substances placed within containment vessel 324 through Inlet opening 326, causing the substances to produce gaseous materials. As further non-limiting and non-exhaustive examples, heat source 350 could also be: an electrical heating source which is battery or wall power or rechargeable battery, or otherwise energized, or a catalytic burner, an exothermic chemical reaction, or other type of heating source.

A thermostat or other heat control device may be used with heat source 350 to control its heat used.

Heat source 350 may be disposed external to containment vessel 324, or as an immersion heater internal to containment vessel 324, or in other disposition.

Heat source 350 heats the substances that have been placed within vessel 324 and causes the substances to produce gaseous material.

Hand squeeze bulb 340 is then squeezed and released repeatedly. Squeezing causes gaseous materials within hand squeeze bulb 340 to be pushed out through one-way hand squeeze bulb exit valve 344, and subsequently out through tip 348 of needle 346.

Releasing hand squeeze bulb 340, results in air being sucked into forward vent opening 328, then mixing with gaseous elements emanating from heated substances contained within containment vessel 324.

These mixed gaseous elements then pass into the interior of hand squeeze bulb 340 by passing through one-way cartridge exit valve 334.

Thus squeezing and releasing squeeze bulb 340 repeatedly, has the net result of mixing air entering into forward vent opening 328 with gaseous materials produced by heating substances, and then pumping the air mixed gaseous materials out through needle tip 348.

Gaseous transference embodiment 332 may be used with a variety of substances, including, but not limited to, as non-limiting and non-exhaustive examples: aromatherapy oils, herbs, perfumes and personal scents, flavorings, fragrances, as well as many other substances, at least in their solid, powder, liquid and/or other forms.

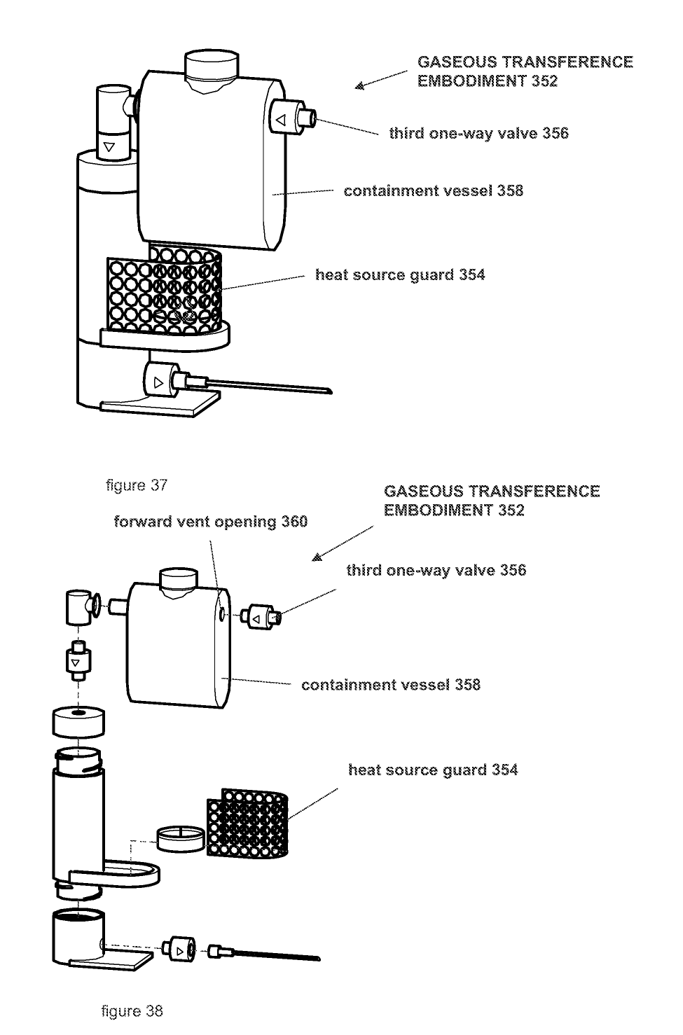

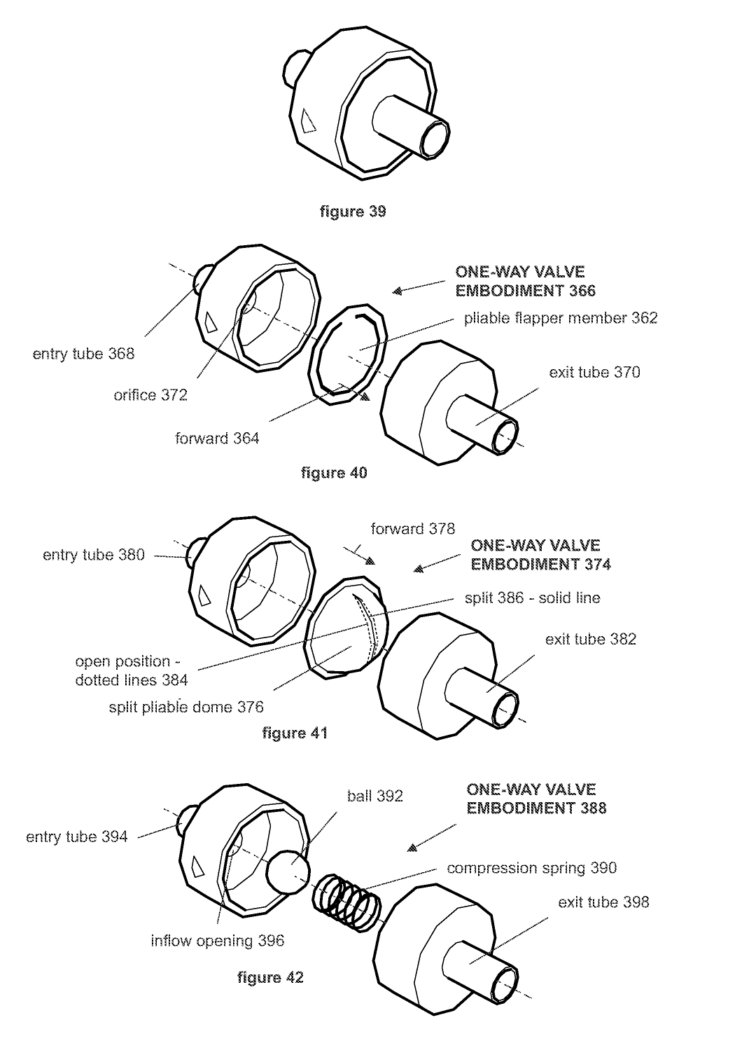

Gaseous Transference Embodiment 352—FIGS. 37 and 38:

Gaseous transference embodiment 352 is similarly constructed to gaseous transference embodiment 332, but embodiment 352 includes heat source guard 354 and third one-way valve 356.

Heat source guard 354 helps protect the user and/or the surrounding environment, from receiving burns, or being expose to an ignition source.

Third one-way valve 356, prevents heat generated gaseous material inside of containment vessel 358 from escaping out of forward vent opening 360 and into the surrounding environment. As a non-limiting and non-exhaustive example, it may be very useful to inject gaseous fragrances into garment bags containing clothes, but the same fragrances may not be desirable in the room air surrounding the garment bags (a bedroom for instance).

Third one-way valve 356 insurers generated gaseous materials do not escape through forward vent opening 360.

Construction Of One-Way Valves—FIGS. 39, 40, 41 and 42:

FIGS. 39 through 42 show various constructions for one-way valves which may be appropriate for use in embodiments shown herein.

FIG. 39 is a perspective showing the exterior appearance of a fully assembled one-way valve, which can be of any one of the constructions shown in FIGS. 40, 41 and 42, or of other design.

One-Way Valve Embodiment 366—FIG. 40:

FIG. 40 is a perspective exploded view of a one-way valve embodiment 366 utilizing pliable flapper member 362, which moves forward 364, and out-of-the-way of fluid passing forward 364 from entry tube 368, to exit tube 370, but, if and when flow is reversed, pliable flapper member 362 is pressed backward to cover orifice 372 which leads to entry tube 368, thus preventing reverse flow.

As both non-limiting and non-exhaustive examples, pliable flapper member 362 may be constructed from: rubber, silicon rubber, other elastomers, polypropylene, polyethylene, vinyl, urethane, or other suitable material(s).

One-Way Valve Embodiment 374—FIG. 41:

FIG. 41 is a perspective exploded view of one-way valve embodiment 374, which utilizes split pliable dome 376, configured to, under forward 378 pressure from fluid entering entry tube 380, open (dotted lines 384 showing open position) split 386 (shown in solid line), and allow forward 378 flow of fluid out exit tube 382.

If and when flow is reversed, split 386 is pressured closed, thus preventing reverse flow.

As both non-limiting and non-exhaustive examples, split pliable dome 376, may be constructed from: rubber, silicon rubber, other elastomers, polypropylene, polyethylene, vinyl, urethane, or other suitable material(s). Split 386 may be molded in or cut in, utilizing a sharp blade.

One-Way Valve Embodiment 388—FIG. 42:

FIG. 42 shows one way valve embodiment 388, which utilizes compression spring 390, pressing ball 392 against entry tube 394 inflow opening 396, to achieve unidirectional flow from entry tube 394 out to exit tube 398.

Ball 392, is pressed to seat in entry tube 394 inflow opening 396 when flow is reversed, thus preventing reverse flow.

It is advantageous that any valves or mechanisms that are exposed to smoke or other gaseous matter be easy to clean. In practical terms, this may mean making certain parts disassemble able, and/or making them from nonstick materials, as described herein.

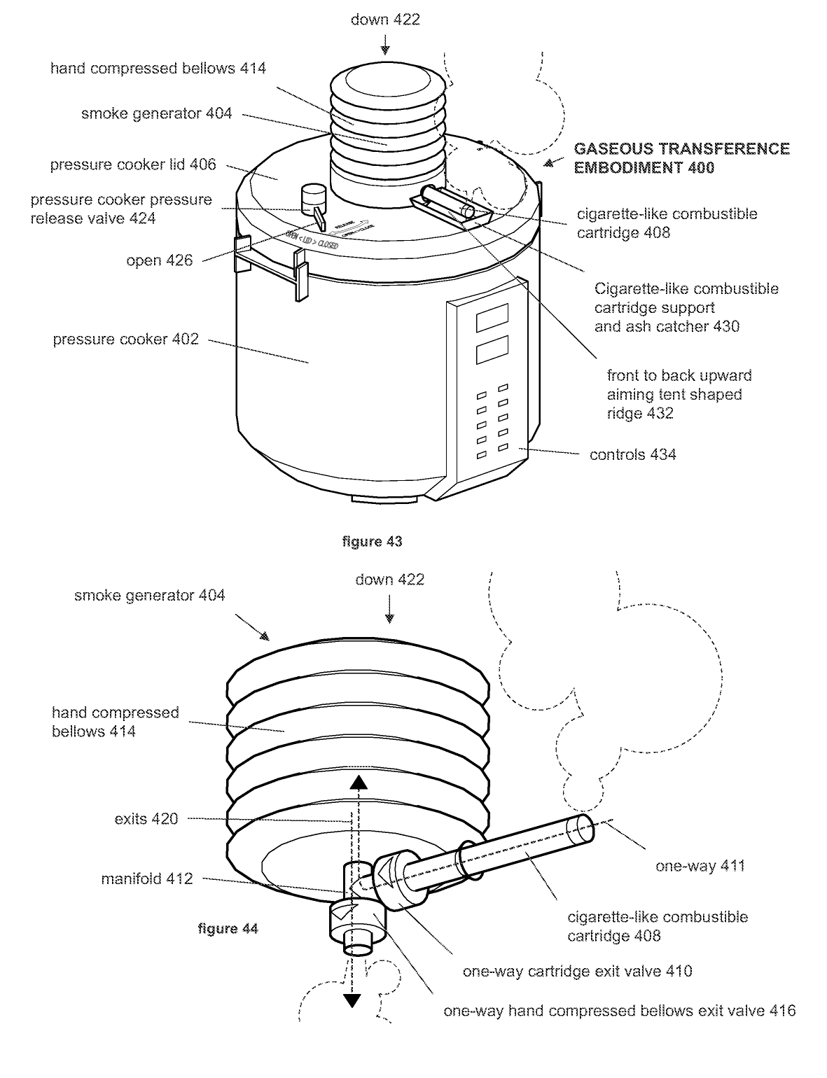

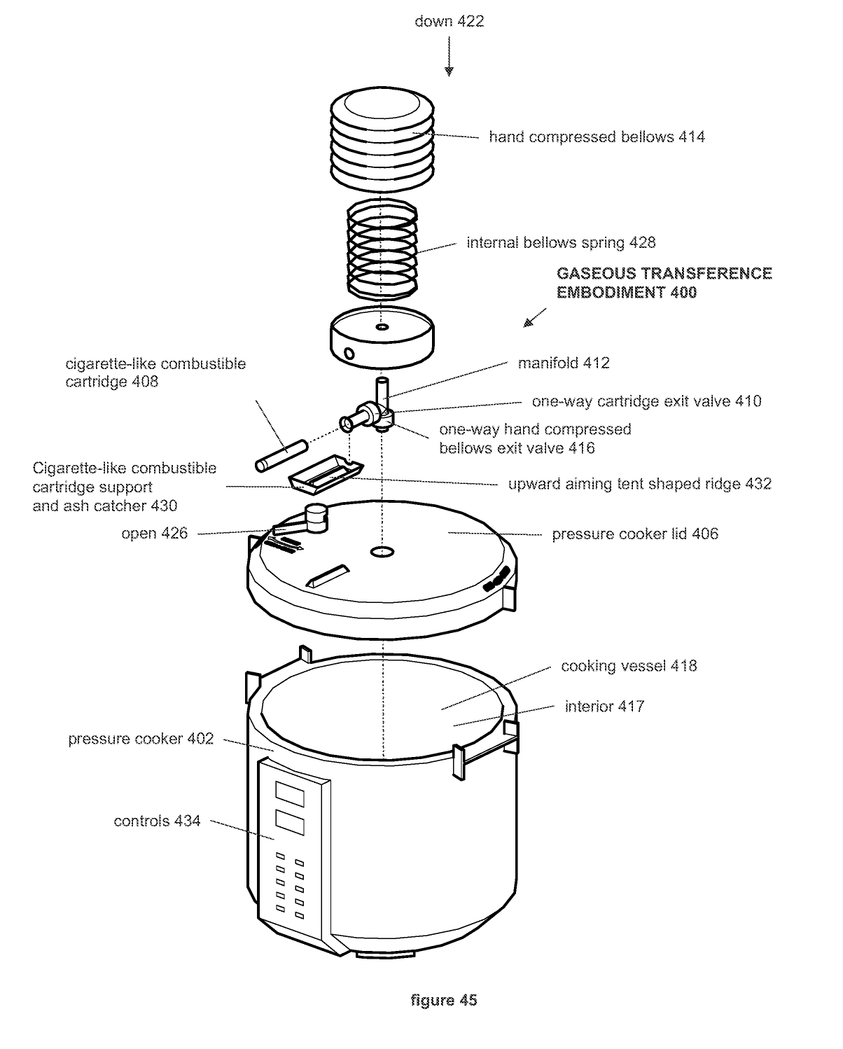

Gaseous Transference Embodiment 400—FIGS. 43, 44, and 45:

FIGS. 43, 44, and 45 show gaseous transference embodiment 400, which is essentially pressure cooker 402, with smoke generator 404 attached to pressure cooker lid 406 (FIG. 43).

Smoke generator 404 is comprised of cigarette-like combustible cartridge 408, linked to the intake of one-way cartridge exit valve 410, which allows only one-way 411 flow from cigarette-like combustible cartridge 408 to manifold 412. Manifold 412 in turn is connected, and in free communication with, both hand compressed bellows 414, and one-way hand compressed bellows exit valve 416.

Hand compressed bellows exits 420 through valve 416, which, on its output end, is connected to interior 417 of cooking vessel 418.

In operation, as both a non-limiting and a non-exhaustive example, cigarette-like combustible cartridge 408 is lit while hand compressed bellows 414 is repeatedly pushed down 422 and then released, causing air to be sucked into cigarette-like combustible cartridge 408, and helping it to ignite.

After this ignition, hand compressed bellows 414 is again repeatedly pushed down 422 and then released. Each release causes gaseous smoke emanating from lit cigarette-like combustible cartridge 408 to be mixed with incoming 411 air and pulled 411 through one-way cartridge exit valve 410 and into manifold 412, and finally into the interior of hand compressed bellows 414. Each compression causes air mixed with gaseous smoke within hand compressed bellows 414 and manifold 412 (FIG. 44), to flow out 420 through one-way hand compressed bellows exit valve 416, through pressure cooker lid 406, and finally into the interior of cooking vessel 418.

Generally during this process, pressure cooker pressure release valve 424 is in its open 426 position. This operation of introducing air mixed gaseous material into the interior of cooking vessel 418, may be performed before any cooking has occurred, or at any time during or after cooking. Opening 426 pressure release valve 424 during this operation, allows air mixed smoke to enter cooking vessel 418, without the need of overcoming back or static pressures from the interior of capped cooking vessel 418.

This operation of introducing air mixed gaseous materials into the interior of cooking vessel 418, may also be performed with lid 406, not in its fully closed position. This too eliminates the need to overcome back or static pressures.

One-way hand compressed bellows exit valve 416 blocks gaseous and other materials from exiting the interior of cooking vessel 418, during cooking or at other times.

Hand compressed bellows 414, may be of any advantageous size, including substantially larger or smaller than illustrated in FIGS. 43, 44, and 45. It also may be of other constructions, including but not limited to: syringe-type piston construction, hand squeeze bulb, hand crank centrifugal pump construction, motor driven construction including motor driven piston or diaphragm construction, motor driven axial or radial impeller construction, or other motor driven pump construction.

Hand compressed bellows 414 may be constructed from any suitable pliable material including, as non-exhaustive and non-limiting examples: polypropylene, polyethylene, neoprene rubber, silicon rubber, elastomers, as well as other materials.

Internal bellows spring 428, may be present to help maintain the resiliency of hand compressed bellows 414 over time.

Cigarette-like combustible cartridge support and ash catcher 430, through its front to back upward aiming tent shaped ridge 432, both supports cigarette-like combustible cartridge 408, and simultaneously, through its pointed upward facing ridge 432, allows ash to drop away from cigarette-like combustible cartridge 408, and into the bottom of cigarette-like combustible cartridge support and ash catcher 430.

Cigarette-like combustible cartridge support and ash catcher 430 may be constructed without perforations, or may be constructed from screening, or from perforated materials.

Foods can be pressure cooked within cooking vessel 418, and prior to, or simultaneously or subsequently, be infused with smoke or other gaseous material, by the smoke or other gaseous material being introduced into cooking vessel 418, as just described.

Likewise, foods may be also, or exclusively, directly injected with smoke, or other gaseous materials, as described herein, before, during, or after cooking has occurred.

Oven type dry heat cooking, without steam or other created pressures, may also be performed within cooking vessel 418, through controls 434 configured to allow it. Oven type try cooking, with or without dynamic or static pressures deviating from normal atmospheric pressure, may also be performed, some of which are described herein.

Slow cooking, sous vide, and other low heat food preparation methods may also be performed within cooking vessel 418, through controls 434 configured to allow it. Again, as described herein, this may be performed with or without static or dynamic pressures which are above and/or below normal atmospheric pressure.

Dry heat cooking, slow cooking, and/or sous vide food preparation, may be performed with or without gaseous smoke or other gaseous materials being present in cooking vessel 418, or within foods being prepared.

Gaseous transference embodiment 400 may be fabricated at any useful scale, including sizes substantially larger or smaller than those shown.

Gaseous transference embodiment 400 may be configured for gas or electric range top operation, without external power and/or controls 434.

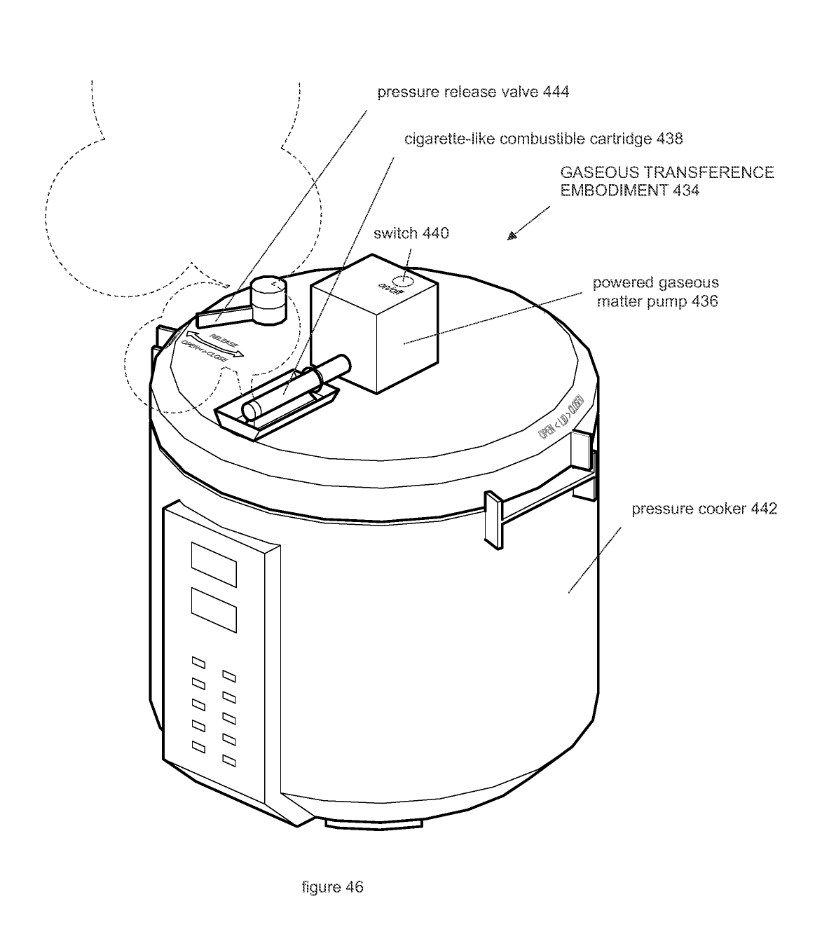

Gaseous Transference Embodiment 434—FIG. 46:

Gaseous transference embodiment 434 is similar in construction to gaseous transference embodiment 400 with hand compressed bellows 414, one-way cartridge exit valve 410, manifold 412, and one-way hand compressed bellows exit valve 416; replaced with powered gaseous matter pump 436.

When activated with switch 440, powered gaseous matter pump 436 pulls air through cigarette-like combustible cartridge 438 where the air is mixed with smoke generated by lit cigarette-like combustible cartridge 438, and powered gaseous matter pump 436 then pushes the combined mixture into the cooking cavity of pressure cooker 442.

In use, as a non-limiting and non-exhaustive example, pressure release valve 444 is placed in its “open” position, switch 440 is placed in its “on” position, and cigarette-like combustible cartridge 438 is lit.

Powered gaseous matter pump 436 is then left on for enough time to fill the cooking vessel of pressure cooker 442 with the appropriate amount of smoke mixture to treat the contents of its cooking vessel. Using switch 440, powered gaseous matter pump 436 may then be turned off, and pressure relief valve 444 then moved to its “close” position, where cooking can begin.

The above process may be repeated several times while cooking a food, or before or after food is cooked, or at other times.

By not adding water to make steam, the embodiment may also oven dry cook while smoking, or at other times.

While steam cooking, or when oven dry cooking, or while smoking at room temperature or below; or at other times, cooking vessel interior air pressure may be: above normal atmospheric air pressure, at normal atmospheric air pressure, or below normal atmospheric air pressure.

Gaseous transference embodiment 434, as well as other pressure cooker-type devices described herein, may make gaseous transference possible at below room temperature, simply by placing the embodiment into a refrigerator or freezer. If desired, an extension cord may be used to provide power to such a gaseous transference embodiment, while it is in a refrigerator or freezer, so that it remains fully functional.

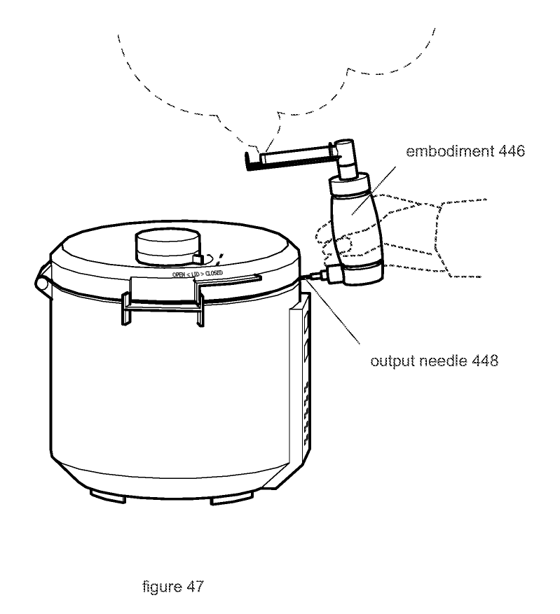

Gaseous Transference Method FIG. 47:

FIGS. 26, 27, 28, 29, 30, 31, and 47, as both non-limiting and non-exhaustive examples, illustrate how embodiments, such as gaseous transference embodiments 230, 250, 310, 332, and 352, might be used to perform gaseous transference, using any closed vessel or container, including, but not limited to: pressure cookers, steam cookers, covered pots, pans, and plates, Tupperware®-type plastic ware, sealed envelopes, plastic food wrap bags, paper bags, or other closed vessels or containers, etc.; and again at any temperature, including: above, at, or below room temperature.

The user simply provides an opening to the closed vessel or container, the opening being large enough to allow entrance of output needle 448 of embodiment 446. This may be accomplished by partially or fully opening the cover of the vessel, as shown in FIG. 47, or by puncturing the vessel or container, or by other means.

Output needle 448 is inserted into the opening and gaseous transference materials then injected into the interior of the vessel or container, and then optionally, the vessel or container may be resealed. A period of time may then be allowed for the gaseous transference to occur under predetermined conditions (temperature, time, air pressure, moisture, etc.).

The above process may be performed only once, or, it may be repeated one or several times before gaseous transference treatment is complete. Where it is repeated, conditions such as temperature, air pressure, time and moisture, may be duplicated within and/or for each repetition, and/or they may be varied within and/or between some or all repetitions.

Embodiment 450:

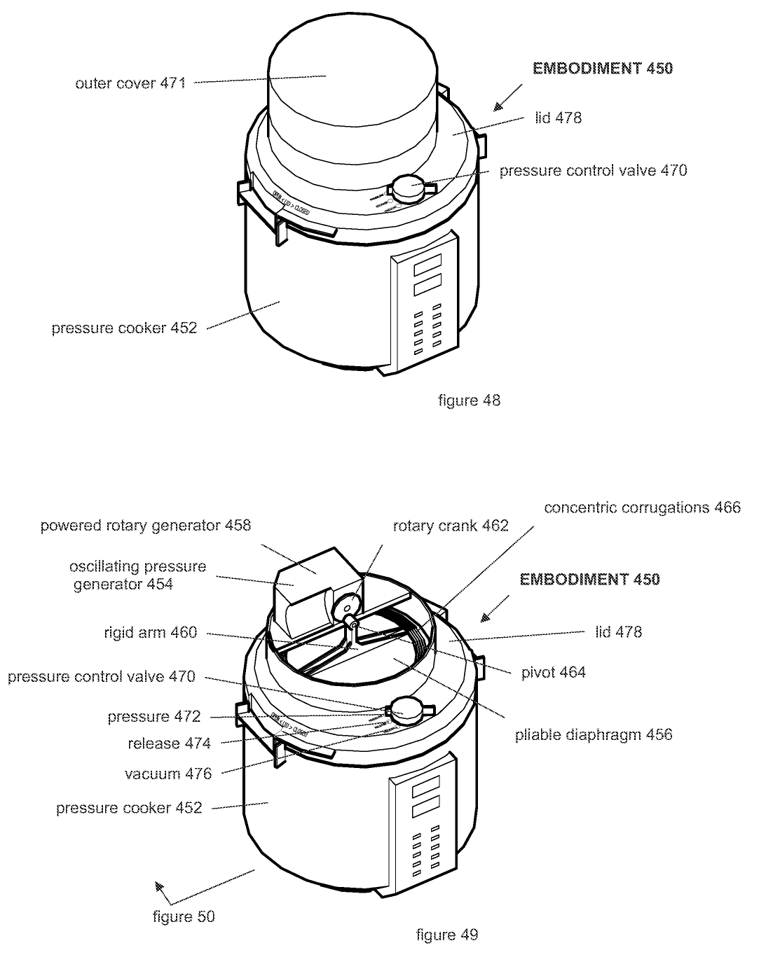

FIGS. 48, 49, and 50, show embodiment 450, comprising: pressure cooker 452, modified to serve as at least: a pressure cooker, a dry oven, and/or a vacuum cooker.

Note, all embodiments shown herein, which utilize a fluid tight cooking vessel, may be used without gaseous transference fluids. As non-limiting and non-exhaustive examples, such embodiments are suitably used to: pressure cook, and/or to vacuum cook, and/or as an oscillating pressure cooker, and/or as an oscillating vacuum cooker, and/or to oven dry cook, and/or to oscillate oven dry cook, and/or to marinate, and/or to infuse fluids into food articles, and/or for other purposes.

Also, all cooking devices shown herein may suitably be heated using internal or external doing: electrical energization, gas energization, range top heat energization, as well as other power source energization.

Pressure cooker 452 may also serve as a pressure/vacuum chamber, to be operated above, at, or below room temperature, and with or without high relative humidity.

Embodiment 450 includes oscillating pressure generator 454, which comprises powered rotary generator 458, which has output through rotary crank 462, which in turn connects to the top of rigid arm 460 through pivot 464. Rigid arm 460 is solidly linked to pliable diaphragm 456.

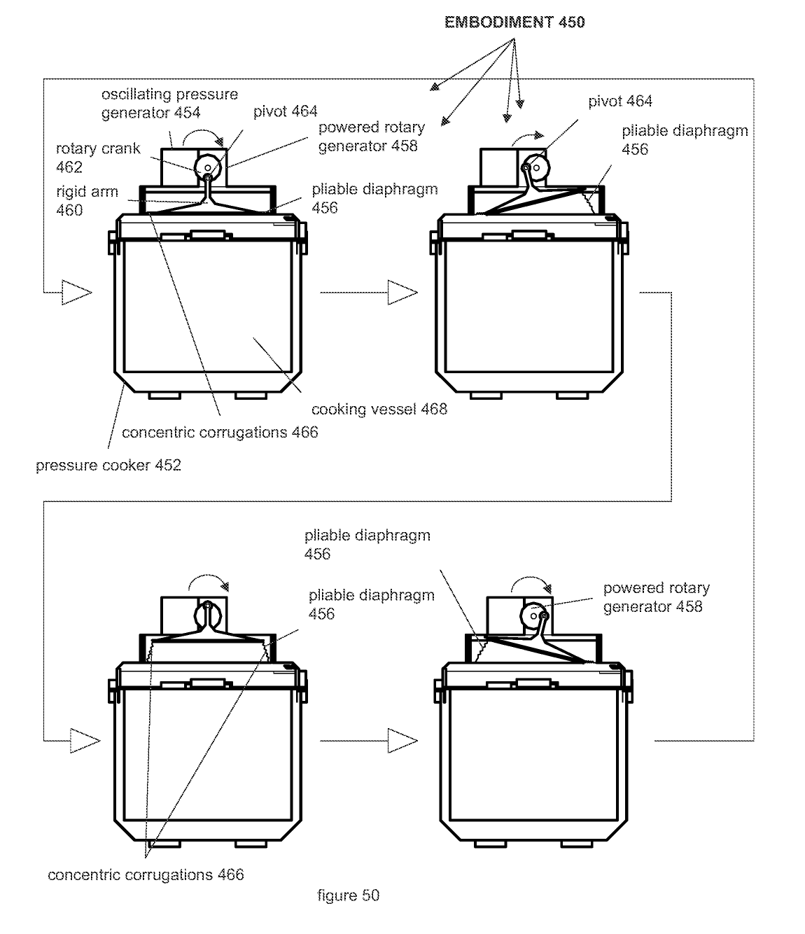

Pliable diaphragm 456 has concentric corrugations 466 proximate to its periphery to allow pliable diaphragm 456 to more easily deform as shown in FIG. 50.

As both non-limiting and non-exhaustive examples, gaseous transference, using embodiment 450, may be accomplished as shown in FIG. 47, by simply cracking open the lid and injecting gaseous transference materials into cooking vessel 468.

As an alternative, embodiment 450 may adapt apparatus shown within this application to facilitate gaseous transference into cooking vessel 468.

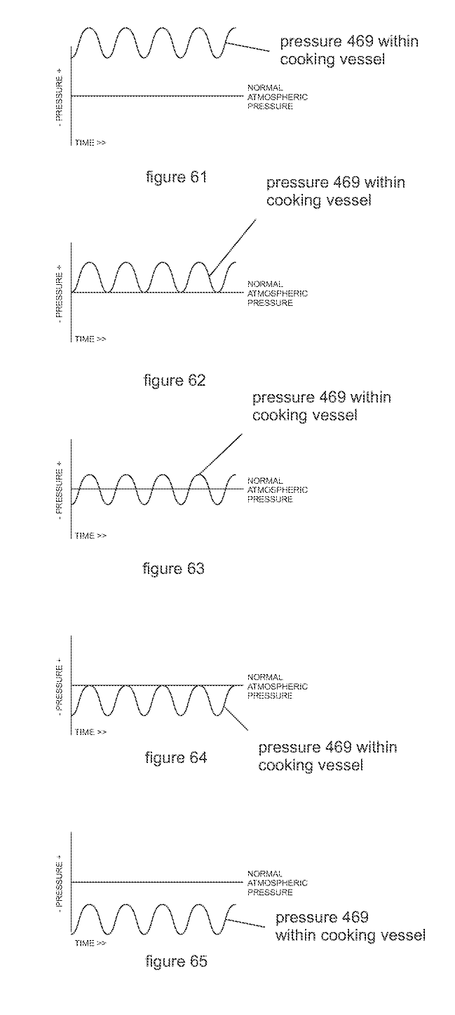

Oscillating the pressure 469 within cooking vessel 468, as shown in FIGS. 61, and/or 62, and/or 63, and/or 64, and/or 65; may facilitate gaseous transference into articles contained within cooking vessel 468, and/or it may improve cooking and/or other treatment of articles within cooking vessel 468.

In gaseous transference operation, articles are placed within cooking vessel 468, and gaseous transference materials are introduced into cooking vessel 468.

An elevated wire and/or open rack placed above cooking vessel's 468 floor, or other apparatus providing gaseous circulation around and/or supporting an article, may facilitate the article's gaseous transference processes and/or its treatment processes and/or its cooking processes.

As both a non-limiting, and non-exhaustive examples, pressure control valve 470 has three positions: pressure 472, release 474, and vacuum 476. Pressure position 472 prevents air from entering or exiting cooking vessel 468. Release position 474 allows free entry and exiting of gases to and from cooking vessel 468. Vacuum position 476, allows air to exit from cooking vessel 468, but does not allow air to enter.

Placing pressure control valve 470 into its release 474 position, may facilitate conveyance of gaseous transference materials into cooking vessel 468.

To achieve oscillating pressure conditions within cooking vessel 468, which are similar to those shown in FIG. 61, where there is a baseline elevated ambient pressure, with pressure oscillations having low points above normal atmospheric pressure, a pressurizing agent, such as water which is boiled, is placed within cooking vessel 468, along with the article to be treated.

Lid 478 is closed, pressure control valve 470 is placed in pressure 472 position, and the treatment procedure initiated. During part or all of the treatment procedure, power rotary generator 458 may be activated, resulting in the operational procedure shown in FIG. 50, which cause gaseous pressures within cooking vessel 468 to rise and fall, with, in this first example, the troughs of the fall being above normal atmospheric pressure, as shown in FIG. 61.

Frequencies of oscillations may range between in excess of several minutes per cycle or more, to 3000 cps or more, depending on what is necessary to achieve the desired outcome.

To achieve oscillating pressure conditions within cooking vessel 468, which are similar to those shown in FIG. 62, where there are pressure oscillations generally touching and above a normal atmospheric pressure baseline, the pressurizing agent may be eliminated, then power rotary generator 458 may be activated, and pressure control valve 470 may be set in pressure position 472.

To achieve oscillating pressure conditions within cooking vessel 468, which are similar to those shown in FIG. 63, where there are pressure oscillation which both exceed and are below normal atmospheric pressure, there need be no pressurizing agent, and pressure control valve 470, may be placed in pressure position 472.

To achieve oscillating pressure conditions within cooking vessel 468, which are similar to those shown in FIG. 64, where there are pressure oscillation which generally peak at normal atmospheric pressure, and fall from there, there need be no pressurizing agent, and pressure control valve 470, may be placed in vacuum position 476.

To achieve oscillating pressure conditions within cooking vessel 468, which are similar to those shown in FIG. 65, where there are pressure oscillation which peak at below normal atmospheric pressure, and fall from there, a pressurizing agent, such as water to be boiled, along with the article to be treated are placed within cooking vessel 468, pressure control valve 470 is placed in its vacuum position 476 and the water boiled.

Heat to maintain boiling water, is then shut off, causing gases within cooking vessel 468 to cool and contract, resulting in a drop in ambient gaseous pressure within cooking vessel 468 which is below normal atmospheric air pressure.

Rotary power generator 458 may then be activated resulting in gaseous pressures within cooking vessel 468 to resemble the graph in FIG. 65.

Embodiment 480:

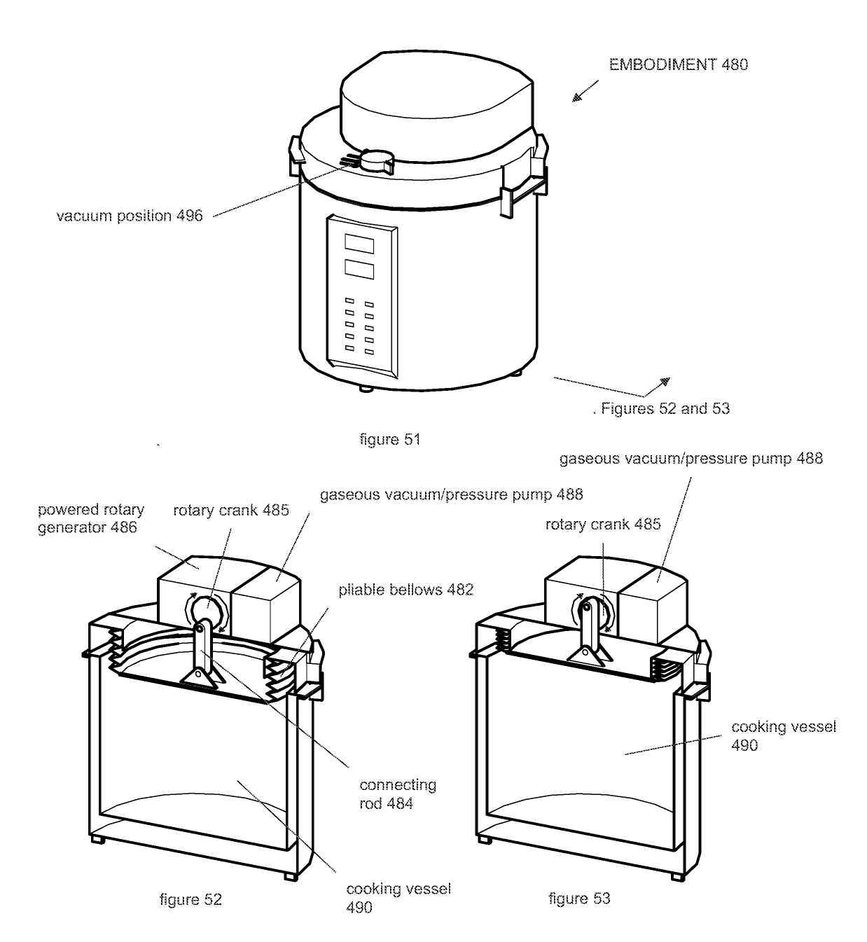

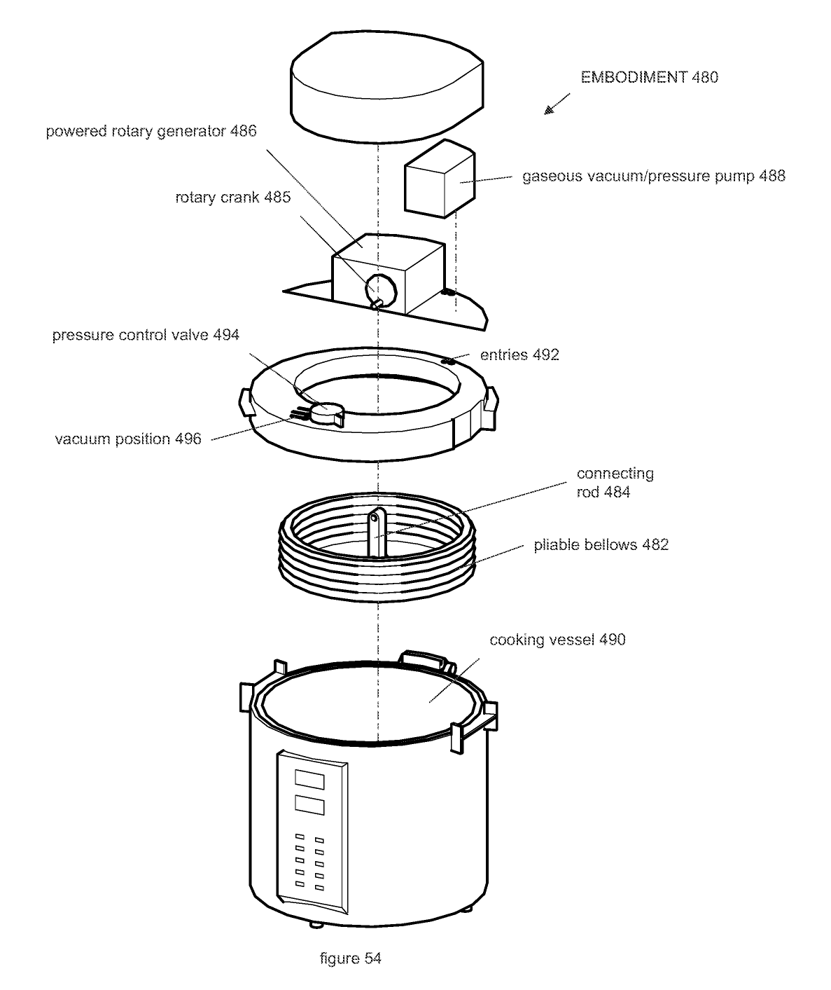

FIGS. 51, 52, 53, and 54, show embodiment 480, which shares several construction and other features with embodiment 450.

Embodiment 480 replaces pliable diaphragm 456 and rigid arm 460 from embodiment 450, with pliable bellows 482, and connecting rod 484.

Powered rotary generator 486, and rotary crank 485 in embodiment 480 are similar to powered rotary generator 458 and rotary crank 462 in embodiment 450, and perform fundamentally similar functions.

Embodiment 480 includes gaseous vacuum/pressure pump 488, which ports directly into cooking vessel 490 through lid entries 492. Gaseous vacuum/pressure pump 488 may raise or lower ambient gaseous pressure within cooking vessel 490 by adding or removing gaseous matter from cooking vessel 490, depending on how the user chooses to activate it.

This in turn, may help facilitate achieving various treatment situations. As non-limiting and non-exhaustive examples, and again referring to the pressure charts illustrated in FIGS. 61 to 65: to achieve pressure oscillations 469 similar to those illustrated in FIG. 61 within cooking vessel 490, pressure control valve 470, may be placed in pressure position 472, and gaseous vacuum/pressure pump 488 may be activated to pressure gases into cooking vessel 490. Simultaneous with this, powered rotary generator 486 may be activated. The resulting pressure oscillations 469 within cooking vessel 490 may resemble the graph in FIG. 61. There is no need to boil water, nor any need for a high humidity treatment environment, which the boiling water might cause.

To achieve pressure oscillations 469 similar to those illustrated in FIG. 65, again no need to boil water, gaseous vacuum/pressure pump 488 is activated in its vacuum mode, and pressure control valve 494 is moved to vacuum position 496, the combination causing gaseous matter to be removed from cooking vessel 490, resulting in a lower overall ambient gaseous pressure within cooking vessel 490. During this condition, activating powered rotary generator 486 may cause gaseous pressure oscillations within cooking vessel 490, which resemble those in the graph of FIG. 65.

Note, as with all devices herein, safety devices which are in common use today, may be adapted to any and/or all such devices.

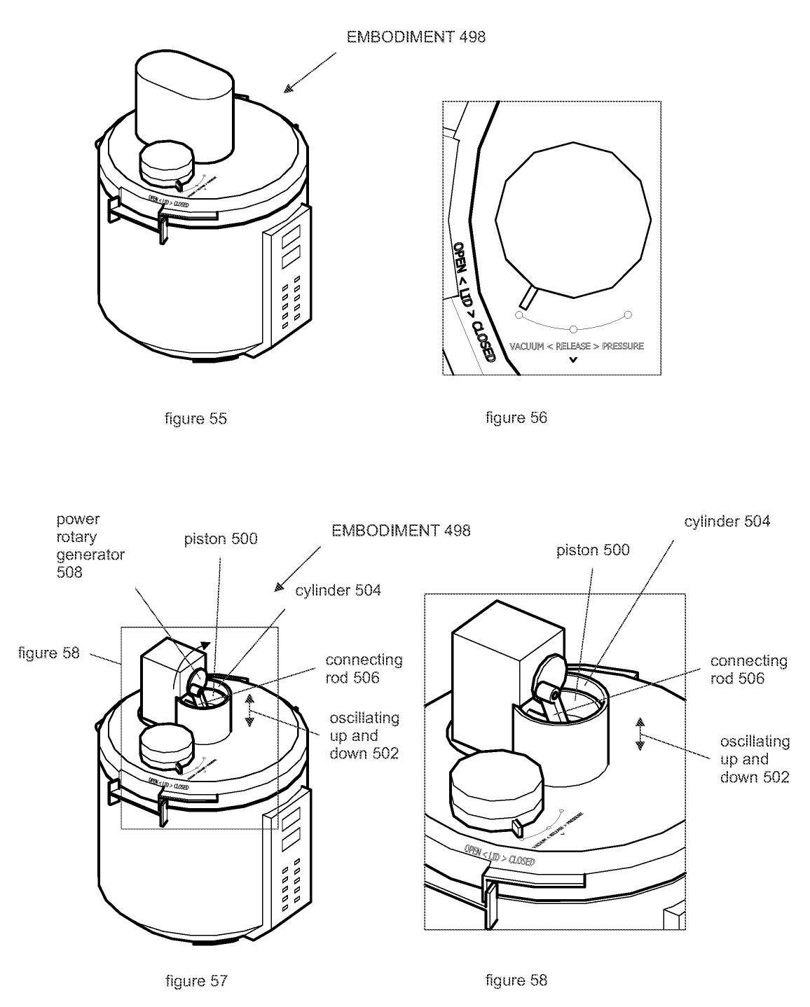

Embodiment 498 (FIGS. 55, 56, 57, and 58):

FIGS. 55, 56, 57, and 58, show embodiment 498, which is similar in many regards to embodiment 450, which is illustrated in FIGS. 48 through 50. However, embodiment 498 replaces pliable diaphragm 456, driven through rigid arm 460, by power rotary generator 458, with piston 500 oscillating up and down 502 within cylinder 504, driven through connecting rod 506, by power rotary generator 508. Cylinder 504 on its lower portion is in open communication with the atmosphere within the cooking vessel of embodiment 498.

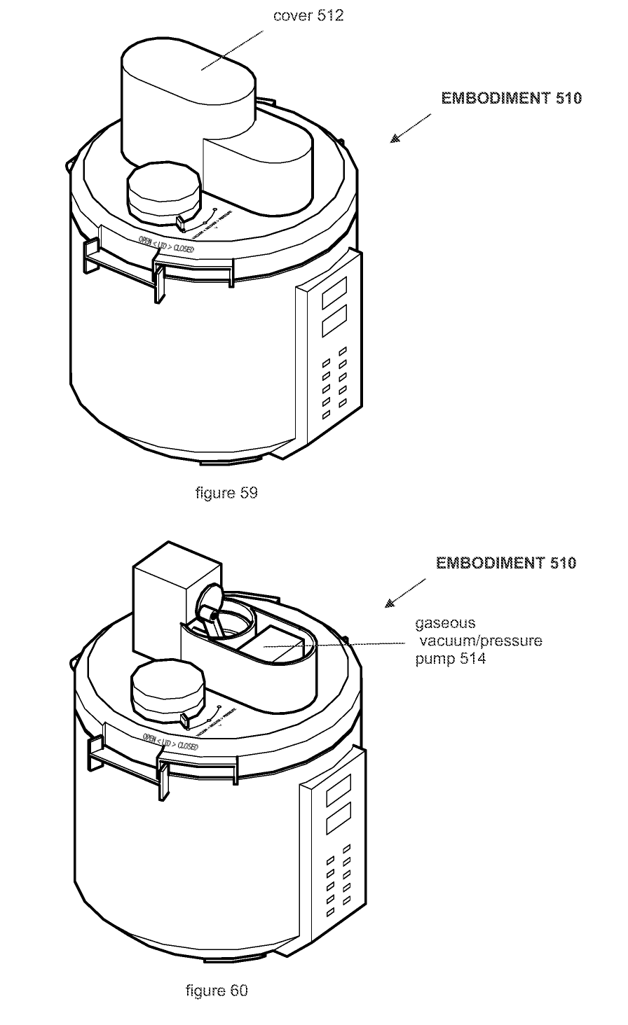

Embodiment 510 (FIGS. 59 and 60):

FIG. 59 shows embodiment 510, and FIG. 60 shows embodiment 510 with cover 512 removed.

Embodiment 510 is similar in most aspects to embodiment 498. However, embodiment 510 includes gaseous vacuum/pressure pump 514, which provide similar functions to gaseous vacuum/pressure pump 488 found in embodiment 480.

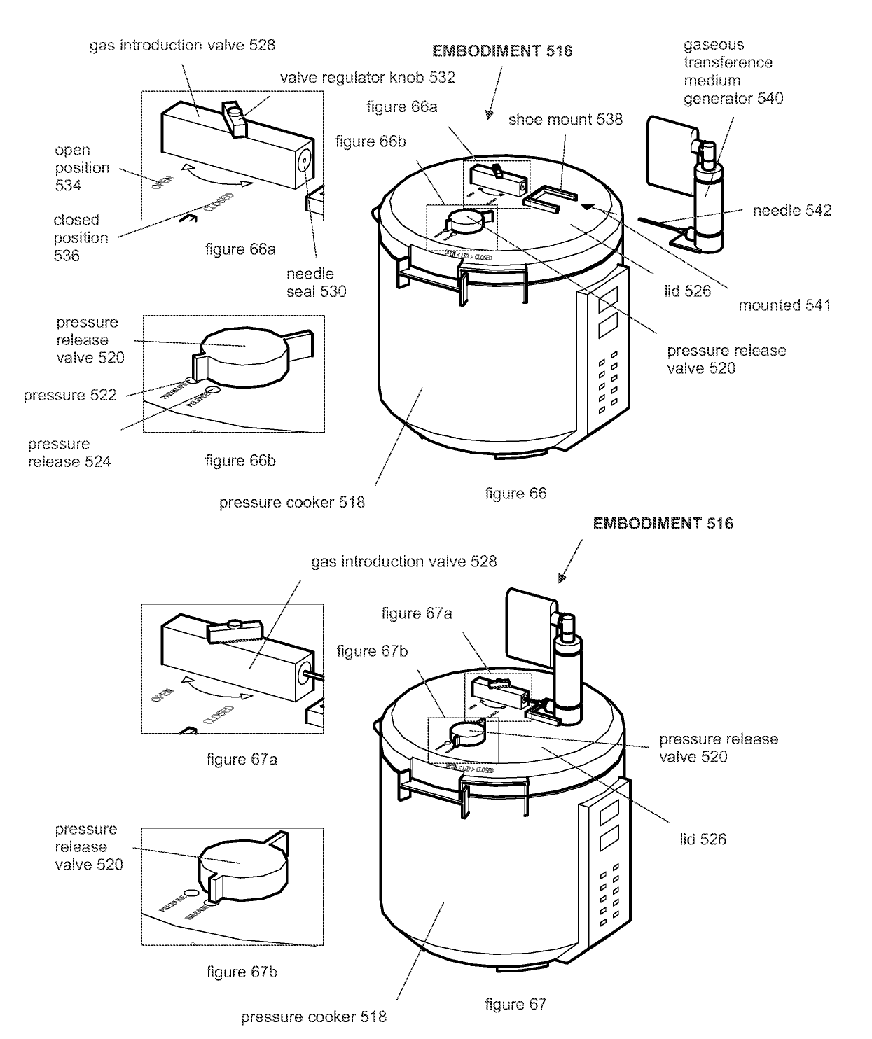

Embodiment 516 (FIGS. 66, 66a, 66b, 67, 67a, and 67b):

Embodiment 516 includes pressure cooker 518 with pressure release valve 520, which has both a pressure 522 position, to allow pressure build up within pressure cooker 518's cooking vessel, and a pressure release 524 position, which allows free escape of gases from within pressure cooker 518's cooking vessel.

Also, mounted on lid 526 of pressure cooker 518, is gas introduction valve 528, which has needle seal 530, and valve regulator knob 532, which in turn has open position 534, which allows free communication between needle seal 530, and pressure cooker 518's cooking vessel; and closed position 536, which closes off communication between needle seal 530, and pressure cooker 518's cooking vessel.

Again, also mounted on lid 526, is shoe mount 538, which is configured to removably mount gaseous transference medium generator 540. Generator 540 in turn, has needle 542, which, when generator 540 is mounted to shoe mount 538, seals and has communication through needle seal 530.

In operation, gaseous transference medium generator 540, is mounted 541 to shoe mount 538, and needle 542 is in communication with gas introduction valve 528 (FIG. 67).

To introduce gaseous transference medium within pressure cooker 518's cooking vessel, generator 540 is activated and valve 528 is moved to its open position 534 (FIGS. 67, and 67a). Simultaneous with this valve 520 is moved to its pressure release 524 position (FIG. 67b), allowing gases to exit from pressure cooker 518's cooking vessel.

Gaseous transference medium is then transferred from gaseous transference medium generator 540 into pressure cooker 518's cooking vessel, concurrent with gases such medium displaces, exiting from pressure release valve 520.

Once the desired amount of gaseous transference medium is within pressure cooker 518's cooking vessel, valve 528 is moved to its closed position 536 (FIG. 66a), gaseous transference medium generator 540 is then removed from shoe mount 538, and valve 520 is moved to its pressure 522 position (FIG. 66b). Treatment of articles within pressure cooker 518, may then commence. The above process may be repeated one or multiple times during any cooking procedure.

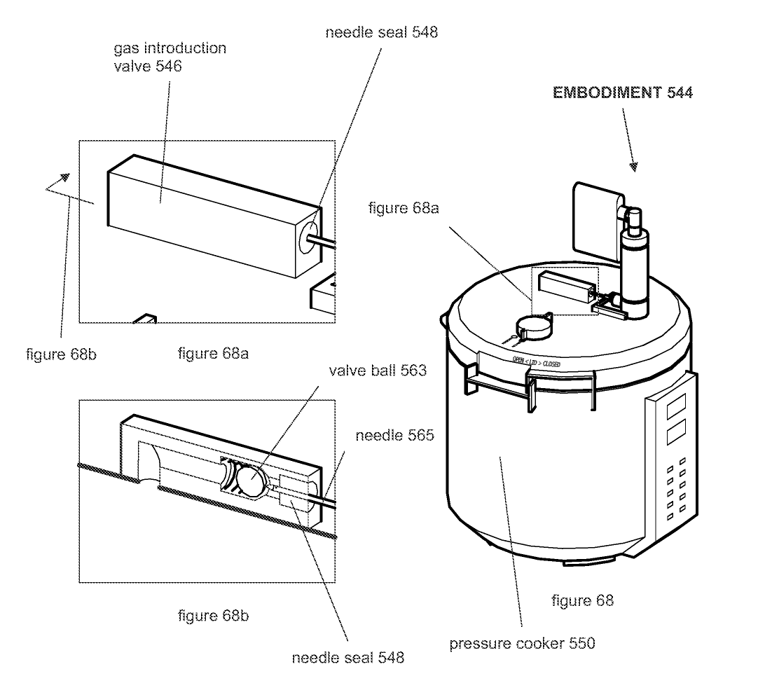

Embodiment 544 (FIGS. 68, 68a, and 68b):

Embodiment 542 is similar to embodiment 516, except gas introduction valve 546 is automatically activated, by needle 565 pressing against and opening valve ball 563 (FIG. 68B), to allow communication between needle 565, and the cooking vessel of pressure cooker 550. Operation of embodiment 544 is similar to that of embodiment 516, except there is no need for operation of gas introduction valve 528.

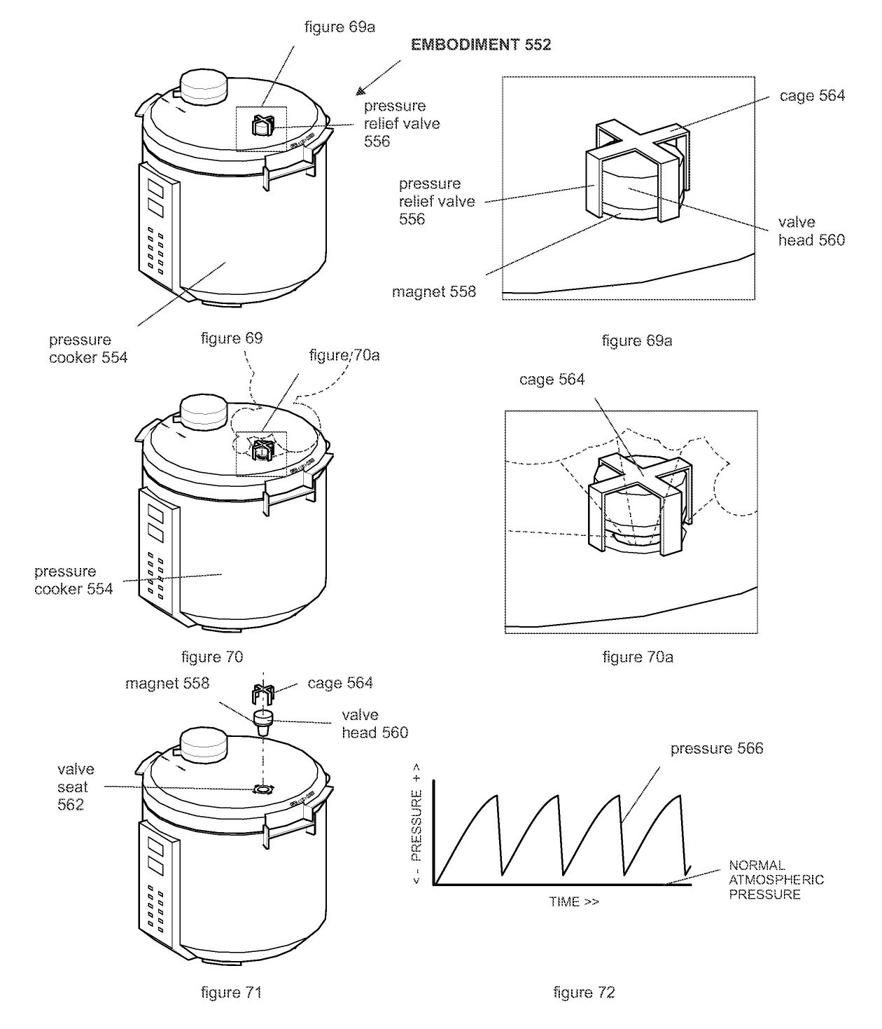

Embodiment 552 (FIGS. 69, 69a, 70, 70a, 71, and 72):

Embodiment 552, includes pressure cooker 554, which has magnetically held down pressure relief valve 556.

Valve 556, has magnet 558, which magnetically couples tapered valve head 560 to valve seat 562, which is in open communication with the interior of the cooking vessel of pressure cooker 554.

Cage 564 contains upward movement of valve head 560, when it is in its release position (FIGS. 70 and 70a).

In operation, as both a non-limiting and non-exhaustive example, embodiment 552 is operated similar to a common pressure cooker, where food and water are introduced into the pressure cooker's cooking vessel, and heat is applied.

However, when pressure inside pressure cooker 554 reaches a predetermined level, sufficient force is applied to valve head 560, to overcome the magnetic couple created by magnet 558, and move tapered valve head 560 from its closed position (FIGS. 69, and 69a), to its open position (FIGS. 70, and 70a), and to remain in its open position until enough pressure is released from the cooking vessel of pressure cooker 544 to allow gravity and magnetism to drop valve head 560 back to its closed, and magnetically coupled, position (FIG. 69, 69a).

This cycling of pressure relief valve 556 may be continued throughout a cooking process. During this cycling, pressure 566 within pressure cooker 554 may rise and fall as shown in FIG. 72. This may help facilitate cooking processes occurring within pressure cooker 554.

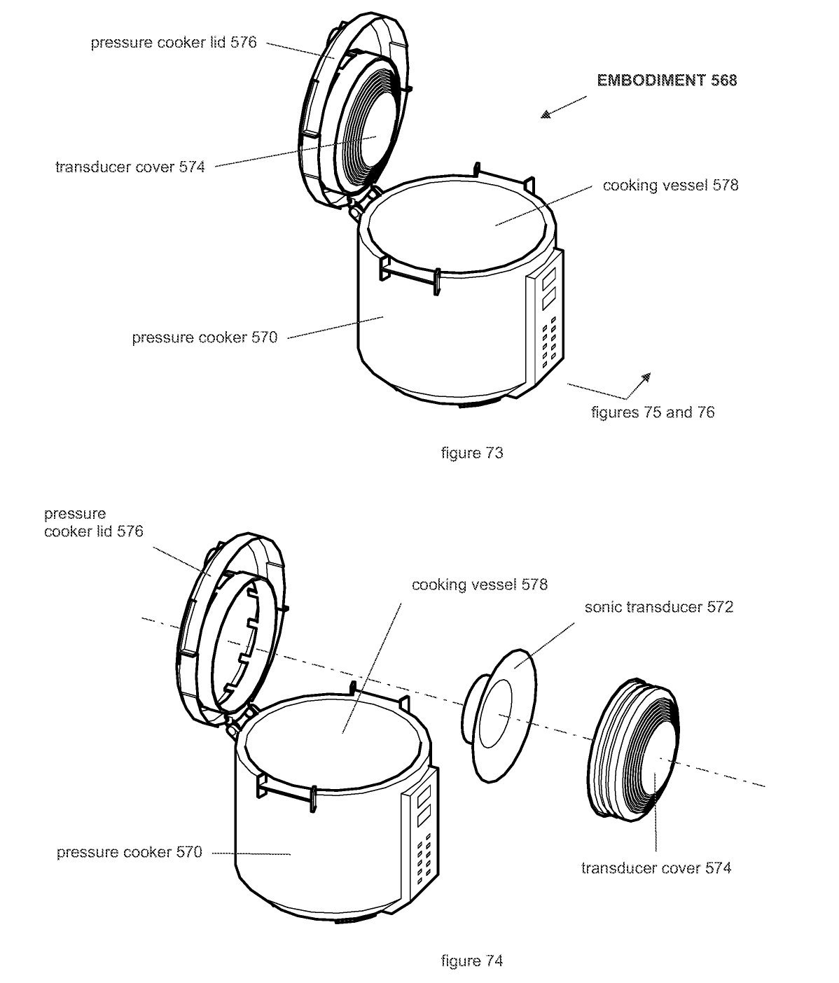

Embodiment 568 (FIGS. 73, 74, 75, and 76):

Embodiment 568 includes: pressure cooker 570, sonic transducer 572, transducer cover 574, pressure cooker lid 576, and cooking vessel 578.

Transducer cover 574 is made of lightweight pliable material (such as non-limiting and non-exhaustive examples: silicone rubber, polyethylene, polypropylene, etc.) which cooperatively vibrates to allow sound waves. What does your medically to pass through them.

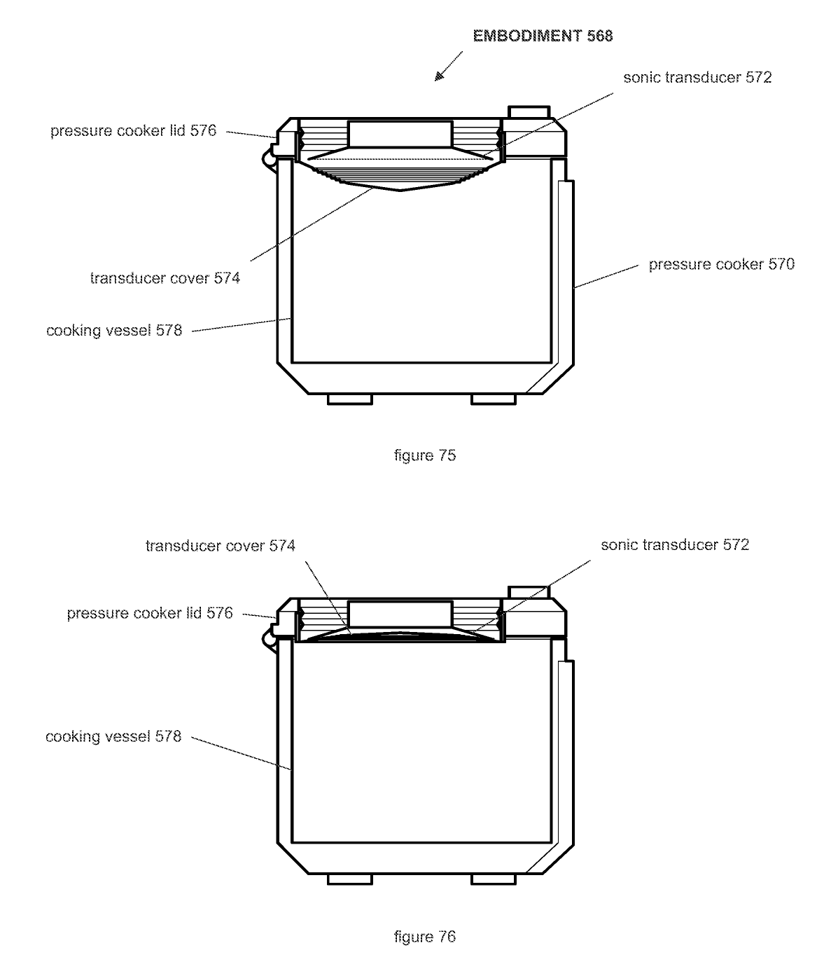

Transducer 572 is hermetically sealed in a chamber formed between transducer cover 574 and pressure cooker lid 576 (as shown in FIGS. 75, and 76).

As shown in FIG. 76, when pressure builds up within cooking vessel 578, transducer cover 574 deforms to allow equalized pressure on its exterior and interior. Such pressure equalization allow sound waves to more easily pass through transducer cover 574.

With proper input, sonic transducer 572 can produce strong sound a waves that may facilitate cooking within pressure cooker 570.

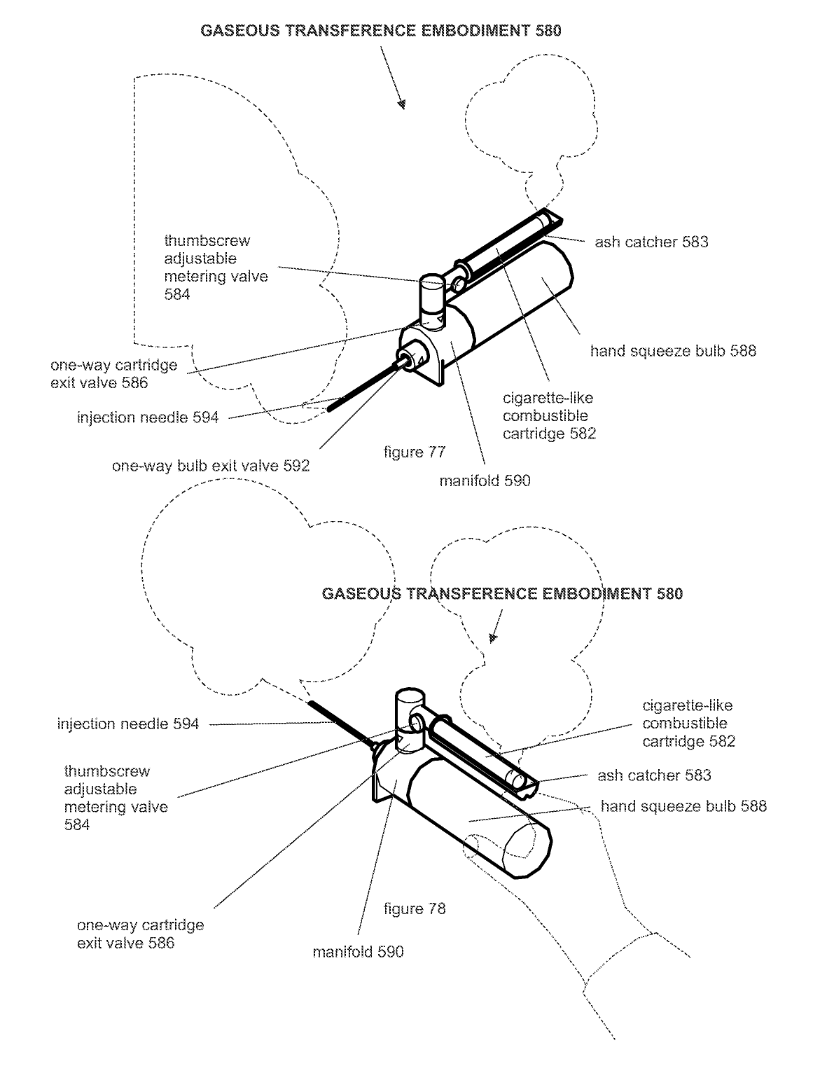

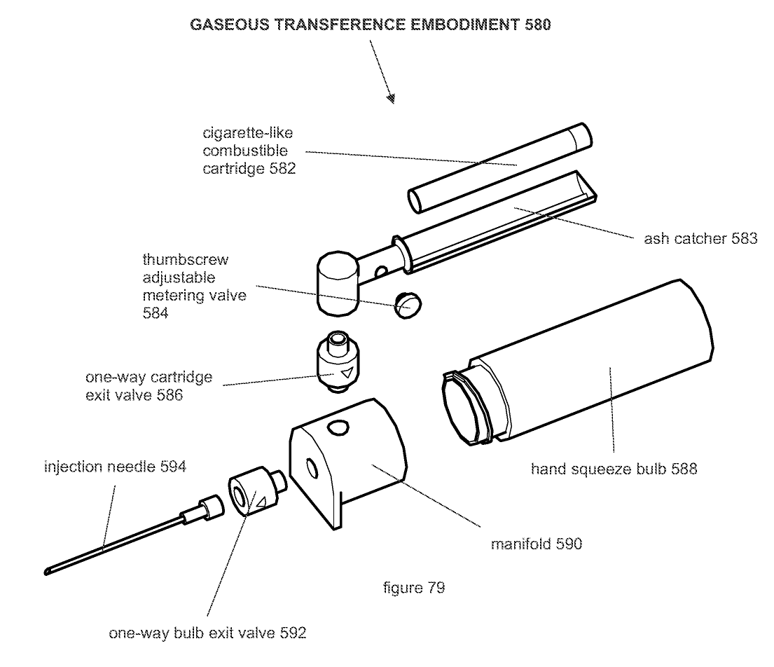

Embodiment 580 (FIGS. 77, 78, and 79):

Embodiment 580 comprises: cigarette-like combustible cartridge 582, ash catcher 583, thumbscrew adjustable metering valve 584, one-way cartridge exit valve 586, hand squeeze bulb 588, manifold 590, one-way bulb exit valve 592, and injection needle 594.

Its principles of operation are similar to embodiment 196 described earlier herein. Cigarette-like combustible cartridge 582 is lit while simultaneously repetitiously pumping hand squeeze bulb 588. Each crushing stroke of bulb 588, exhales air within it out through injection needle 594. Each release of squeeze bulb 588 pulls air through one-way cartridge exit valve 592, as metered by thumbscrew adjustable metering valve 584. Setting of valve 584 controls the rate at which hand squeeze bulb 588 refills with air enriched with the burning product from cigarette-like combustible cartridge 582.

Repetitious hand squeezing of bulb 588, thus has the net effect of pumping out under pressure through injection needle 594, the gaseous transference product from burning cartridge 582.

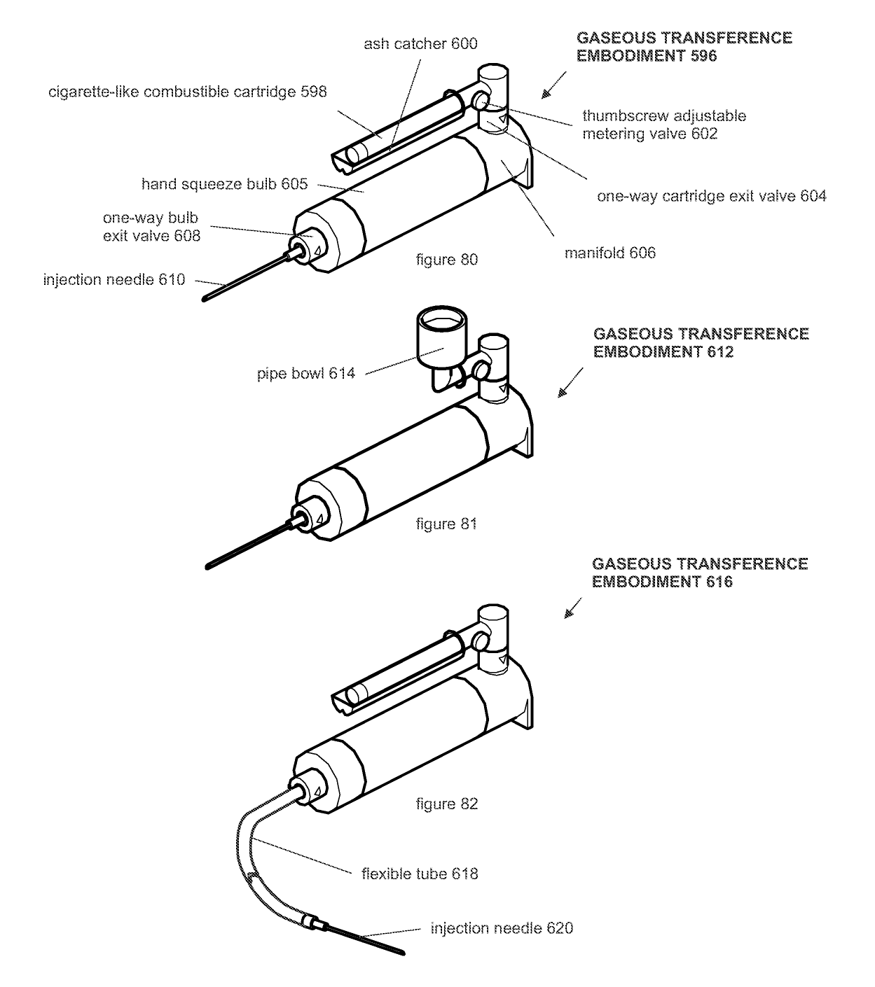

Embodiment 596 (FIG. 80):

Gaseous transfer embodiment 596 comprises: cigarette-like combustible cartridge 598, ash catcher 600, thumbscrew adjustable metering valve 602, one-way cartridge exit valve 604, hand squeeze bulb 605, manifold 606, one-way bulb exit valve 608, and injection needle 610.

Once again, repetitious hand squeezing of bulb 605, has the net effect of pumping out under pressure through injection needle 610, the gaseous transference product from burning cartridge 598.

Embodiment 612 (FIG. 81):

Embodiment 612 is identical to embodiment 596, except that cigarette-like combustible cartridge 598 and ash catcher 600 are replaced with pipe bowl 614, which may receive loose materials, which, when ignited, will produce gaseous transference medium.

Cigarette-like combustible cartridge 598, along with ash catcher 600 may be constructed so that they are easily interchangeable by a user, with pipe bowl 614.

Embodiment 616 (FIG. 82):

Embodiment 616 is identical to embodiment 596, except injection needle 610, has been replaced with flexible tube 618, which has injection needle 620 at its far end. This may improve convenience and flexibility for users.

What is claimed is:

1. A gaseous transference device comprising:
a generally vertical vessel configured to hold gaseous transference medium,
a vessel egress configured to receive gaseous transference medium from the vessel,
a unidirectional first valve coupled to the egress, and configured to admit gaseous transference medium from the vessel, but not allow gaseous medium to flow back to the vessel,
a hand deformable pliable chamber coupled to the valve output, opposite the valve input from the vessel,
a unidirectional second valve coupled to the chamber, and configured to receive gaseous transference medium from the chamber, but not allow gaseous transference medium flow back into the chamber,
an outlet member coupled to the output of the second valve, and configured to receive gaseous transference medium from the second valve, and to deliver such gaseous transference medium proximate to an object to be with such medium.

2. The gaseous transference device of claim 1, further including the object being a comestible.

3. The gaseous transference device of claim 2, wherein the gaseous transference medium alters the taste of the object.

4. The gaseous transference device of claim 2, wherein the gaseous transference medium alters the olfactory quality of the object.

5. The gaseous transference device of claim 2, wherein the gaseous transference medium alters the texture of the object.

6. The gaseous transference device of claim 1, wherein the gaseous transference medium comprises woods moke from wood combusted within the vessel.

7. The gaseous transference device of claim 1, wherein the unidirectional first valve is configured to be disassembled by the user.

8. The gaseous transference device of claim 1, wherein the unidirectional second valve is configured to be disassembled by the user.

9. The gaseous transference device of claim 1, wherein the outlet member is configured to penetrate into a comestible to be treated to inject gaseous transference medium originating from the vessel into the comestible.

10. The gaseous transference device of claim 1, wherein there is a removable cap, which from time to time covers the vessel.

11. A gaseous transference device comprising:
a combustible wrapper containing gaseous transference generation medium;
a unidirectional pump coupled to an open end of the combustible wrapper, and configured to admit gaseous transference material generated by combustion of the gaseous transference generation medium within the wrapper; and
the unidirectional pump also coupled to an outlet member configured to receive gaseous transference material from the pump, and to direct the gaseous transference material toward an object to be treated with such materials.

12. The device of claim 11 wherein the unidirectional pump comprises a hand deformable pliable chamber.

13. The device of claim 11 wherein the unidirectional pump comprises a first unidirectional valve and a second unidirectional valve.

14. The device of claim 11 wherein the object is a comestible.

15. The device of claim 11 wherein the object is not alive.

16. A gaseous transference device comprising:
a gaseous transference material generator; and
a unidirectional pump configured to receive gaseous transference material from the generator and direct the gaseous transference material to an object to be treated with such materials, the unidirectional pump including a hand deformable pliable chamber.

17. A gaseous transference device comprising:
a gaseous transference material generator; and
a unidirectional pump configured to receive gaseous transference material from the generator and direct the gaseous transference material to an object to be treated with such material via a rigid tubular member which is fixedly coupled to the pump.

18. A gaseous transference device comprising:
a gaseous transference material generator configured to generate gaseous transference material by combusting gaseous transference generation medium;
a unidirectional pump configured to receive gaseous transference material from the generator and direct the gaseous transference material to an object to be treated with such materials; and
an extinguisher member configured to selectively control air flow to the combusting gaseous transference generation medium.

19. A gaseous transference device comprising:
a gaseous transference material generator configured to generate gaseous transference material by vaporizing generation liquid; and
a unidirectional pump configured to receive gaseous transference material from the generator and direct such gaseous transference material to an object to be treated with such material.

20. The device of claim 19 wherein the generator includes a heater configured to facilitate vaporizing generation liquid.

21. A gaseous transference device comprising:
a gaseous transference generator configured to generate gaseous transference material;
a pump which pumps gaseous transference material from the generator; and
an air containment chamber, fixedly coupled to the pump, configured to receive gaseous transference material from the pump and hold comestibles to be treated with the material.

22. A device to cook comestibles, comprising:
an airtight chamber configured to receive comestibles to be cooked within the chamber;
a power driven pressure modulator coupled to the chamber, and configured to oscillate air pressure, up and down, within the chamber; and
a heat source configured to heat comestibles to cooking temperature while air pressure is being oscillated up and down within the chamber by the modulator.

23. The device of claim 22 including a pump configured to introduce pressurized air into the chamber.

24. The device of claim 22 including a pump configured to reduce air pressure within the chamber.

25. The device of claim 22 wherein air pressure within the chamber oscillates with peaks and troughs above ambient air pressure surrounding the exterior of the chamber.

26. The device of claim 22 wherein air pressure within the chamber oscillates with peaks and troughs at or above ambient air pressure surrounding the exterior of the chamber.

27. The device of claim 22 wherein air pressure within the chamber oscillates with peaks and toughs above and below ambient air pressure surrounding the exterior of the chamber.

28. The device of claim 22 wherein air pressure within the chamber oscillates with peaks and troughs at or below ambient air pressure surrounding the exterior of the chamber.

29. The device of claim 22 wherein air pressure within the chamber oscillates with peaks and troughs below ambient air pressure surrounding the exterior of the chamber.

30. A device to marinade comestibles, comprising:
an airtight chamber configured to simultaneously receive and marinade comestibles;
a power driven pressure modulator, coupled to the chamber, and configured to repetitively oscillate air pressure up and down within the chamber.

31. The device of claim 30 wherein the pressure modulator is configured to oscillate air pressure within the chamber with peaks and troughs above ambient air pressure surrounding the exterior of the chamber.

32. The device of claim 30 wherein the pressure modulator is configured to oscillate air pressure within the chamber with peaks and troughs at and above ambient air pressure surrounding the exterior of the chamber.

33. The device of claim 30, wherein the pressure modulator is configured to oscillate air pressure within the chamber with peaks and troughs above and below ambient air pressure surrounding the exterior of the chamber.

34. The device of claim 30 wherein the pressure modulator is configured oscillate air pressure within the chamber with peaks and thoughts at and below ambient air pressure surrounding the exterior of the chamber.

35. A method of treating an object with gaseous transference material, including use of: a gaseous transference material generator, a positive displacement pump which pumps gaseous transference material from the generator, and a containment void, which receives gaseous transference material from the pump, the method comprising:
placing an object to be treated with gaseous transference material within the void;
activating the generator;
activating the pump; and
pumping, via the pump, gaseous transference material from the generator into the void under positive pressure relative to ambient air pressure surrounding the void.

36. A gaseous transference device comprising:
a gaseous transference generator configured to generate gaseous transference material;
a pump configured to pump gaseous transference material from the generator;
an air containment chamber configured to be selectively coupled and decoupled with the pump; and
the chamber configured to receive gaseous transference material from the pump while holding comestibles to be treated with the material.

37. A device to cook comestibles, comprising:
an airtight chamber configured to receive comestibles to be cooked within the chamber;
an air pressure release valve, held in closed position by a magnetic coupling, configured to open and remain open under urging from air pressure within the chamber, and the valve being configured to again close when such valve opening results in air pressure within the chamber being reduced below a predetermined level; and
a heat source configured to heat comestibles within the chamber to a cooking temperature.

38. A device to cook comestibles, comprising:
a chamber configured to receive comestibles to be cooked within the chamber;
a heat source configured to heat comestibles within the chamber to a cooking temperature; and
a sound transducer, disposed within the chamber, configured direct sound waves at objects being cooked within the chamber.

39. The device of claim 38 wherein the chamber is airtight.

40. A method of cooking a comestible in an airtight chamber configured to hold comestibles while they are being cooked, including a heater configured to heat, comestibles within the chamber to a cooking temperatures, a modulator configured to oscillate, up and down, air pressure within the chamber while comestibles are being cooked, and the method comprising:
placing a comestible within the chamber;
closing the chamber airtight;
activating the modulator; and
activating the heater.
